(19) United States
(12) Patent Application Publication
(10) Pub. No.: US 2026/0154865 A1
(43) Pub. Date: Jun. 4, 2026

(54) SYNTHESIS METHOD AND APPARATUS FOR VIRTUAL EQUIPMENT, DEVICE, AND STORAGE MEDIUM

(71) Applicant: TENCENT TECHNOLOGY (SHENZHEN) COMPANY LIMITED, Shenzhen (CN)

(72) Inventor: Yunpeng GUO, Shenzhen (CN)

(21) Appl. No.: 19/458,898

(22) Filed: Jan. 25, 2026

Related U.S. Application Data
(63) Continuation of application No. PCT/CN2024/136720, filed on Dec. 4, 2024.

(30) Foreign Application Priority Data
Jan. 5, 2024 (CN) 202410029209.4

(51) Int. Cl. G06T 11/10

(52) U.S. Cl. CPC G06T 11/10; G06T 2200/24

(57) ABSTRACT

This application provides a synthesis method and apparatus for a virtual equipment, an electronic device, a computer-readable storage medium, and a computer program product. The method includes: displaying an equipment selection control in a synthesis interface of a virtual equipment; displaying a target primary virtual equipment and a target secondary virtual equipment that are instructed by the equipment selection instruction to be selected in response to an equipment selection instruction triggered based on the equipment selection control, the target secondary virtual equipment matching the target primary virtual equipment; and displaying a synthesized target virtual equipment in response to an equipment synthesis instruction, the target virtual equipment being obtained by random synthesis based on equipment attributes of the target primary virtual equipment and the target secondary virtual equipment.

### RELATED APPLICATIONS

This application is a continuation of PCT Application No. PCT Application No. PCT/CN 2024/136720, filed on Dec. 4, 2024, which in turn claims priority to Chinese Patent Application No. 202410029209.4, filed on Jan. 5, 2024, which are incorporated by reference in their entirety.

### FIELD OF THE TECHNOLOGY

This application relates to human-computer interaction technologies, and in particular, to a synthesis method and apparatus for a virtual equipment, a device, a storage medium, and a program product.

### BACKGROUND OF THE DISCLOSURE

In massive multiplayer online role-playing games, an equipment system is a system that a player experiences most intensely after playing a game, and the player often invests more energy into the game to obtain more extreme equipment attributes. However, the equipment system in the related art generally only allows players to build and strengthen an equipment, both of which are relatively fixed with low randomness for improving equipment attributes, and extreme attributes of the equipment are consequently lower, which undoubtedly significantly impairs players'pursuit of the equipment.

### SUMMARY

Embodiments of this application provide a synthesis method and apparatus for a virtual equipment, an electronic device, a computer-readable storage medium, and a computer program product, which can improve synthetic randomness of a virtual equipment.

Technical solutions in the embodiments of this application are implemented as follows:

An embodiment of this application provides a synthesis method for a virtual equipment, including displaying an equipment selection control in a synthesis interface of a virtual equipment; displaying a target primary virtual equipment and a target secondary virtual equipment that are instructed by the equipment selection instruction to be selected in response to an equipment selection instruction triggered based on the equipment selection control, the target secondary virtual equipment matching the target primary virtual equipment; and displaying a synthesized target virtual equipment in response to an equipment synthesis instruction, the target virtual equipment being obtained by random synthesis based on equipment attributes of the target primary virtual equipment and the target secondary virtual equipment.

An embodiment of this application provides an electronic device, including a memory, configured to store computer-executable instructions or a computer program; and a processor, configured to execute the computer-executable instructions stored in the memory to implement the synthesis method for a virtual equipment according to the embodiments of this application.

An embodiment of this application provides a non-transitory computer-readable storage medium, having computer executable instructions stored thereon, the computer executable instructions being configured to: when executed by a processor, implement the synthesis method for a virtual equipment according to the embodiments of this application.

In embodiments of this application, an equipment selection control is displayed in a synthesis interface of a virtual equipment. If a user triggers the equipment selection control to transmit an equipment selection instruction, a target primary virtual equipment instructed by the equipment selection instruction to be selected and a target secondary virtual equipment matching the target primary virtual equipment are displayed in the synthesis interface. Accordingly, if an equipment synthesis instruction transmitted by the user is received, a target virtual equipment synthesized by the target primary virtual equipment and the target secondary virtual equipment is displayed in the synthesis interface. The synthesized target virtual equipment is obtained through random synthesis based on equipment attributes of the target primary virtual equipment and the target secondary virtual equipment. Accordingly, randomness of virtual equipment synthesis can be improved, and a possibility that an equipment attribute of the synthesized target virtual equipment reaches an upper limit can be increased to some extent. This enables players pursuing extreme equipment to always have continuous goal pursuits, which is beneficial to expanding equipment depth and increasing synthesis utilization of the virtual equipment.

### BRIEF DESCRIPTION OF THE DRAWINGS

FIG. 1 is a schematic architecture diagram of a synthesis system 100 for a virtual equipment according to an embodiment of this application.

FIG. 2 is a schematic structural diagram of an electronic device 500 according to an embodiment of this application.

FIG. 3 is a schematic flowchart of a synthesis method for a virtual equipment according to an embodiment of this application.

FIG. 4 is a schematic diagram of a synthesis interface of a virtual equipment according to this application.

FIG. 5 is a schematic display diagram of a synthesis interface of a virtual equipment according to an embodiment of this application.

FIG. 6 is a schematic display diagram of a synthesis interface of a virtual equipment according to an embodiment of this application.

FIG. 7 is a schematic display diagram of a synthesis interface of a virtual equipment according to an embodiment of this application.

FIG. 8 is a schematic display diagram of a synthesis preview interface of a virtual equipment according to an embodiment of this application.

FIG. 9 is a schematic display diagram of an equipment field guide according to an embodiment of this application.

FIG. 10 is a schematic diagram of a synthesis result of a virtual equipment according to an embodiment of this application.

FIG. 11 is a schematic diagram of a synthesis result of a virtual equipment according to an embodiment of this application.

FIG. 12 is a schematic flowchart of a synthesis method for a virtual equipment according to an embodiment of this application.

FIG. 13 is a schematic flowchart of a synthesis method for a virtual equipment according to an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts shall fall within the protection scope of this application.

In the embodiments of this application, related data such as user information (for example, a trigger operation of a user, a virtual equipment attribute, or a historical selection rate of a virtual equipment) is involved. When the embodiments of this application are applied to a specific product or technology, a user's permission or consent needs to be obtained, and related data collection, use, and processing need to comply with relevant laws and standards of a relevant country and region.

In the following description, the term “some embodiments” describes subsets of all possible embodiments, but “some embodiments” may be the same subset or different subsets of all the possible embodiments, and can be concatenated with each other without conflict.

In the following description, the term “first\second” is merely configured for distinguishing between similar objects, and does not represent a specific sorting for the objects. A specific sequence or an order of “first\second” may be interchanged when allowed, so that the embodiments of this application described herein can be implemented in a sequence other than that shown or described herein.

In embodiments of this application, the term “module” or “unit” refers to a computer program having a predetermined function or a part of a computer program, and works together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or the unit.

Unless otherwise defined, meanings of all technical and scientific terms used in this specification are the same as those usually understood by a person skilled in the art to which this application belongs. The terms used in this specification are merely intended to describe the embodiments of this application, and are not intended to limit this application.

Before the embodiments of this application are further described in detail, a description is made on nouns and terms in the embodiments of this application, and the nouns and terms in the embodiments of this application are applicable to the following explanations.
1) A client is an application program running in a terminal that is configured for providing various services, such as a video playback client and a game client.
2) “In response to” is configured for representing a condition or a status on which a performed operation depends, and when a dependent condition or status is met, one or more performed operations may be in real time or may have a set delay. Unless otherwise specified, there is no limitation on an execution sequence of a plurality of operations performed.
3) A virtual scene is a virtual scene that an application program displays (or provides) when running on a terminal. The virtual scene may be a simulated environment for a real world, may be a semi-simulated semi-virtual environment, or may be a pure virtual environment. The virtual scene may be any one of a two-dimensional virtual scene, a 2.5-dimensional virtual scene, or a three-dimensional virtual scene. A dimension of the virtual scene is not limited in the embodiments of this application. For example, the virtual scene may include a sky, a land, a sea, and the like. The land may include environment elements such as a desert and a city, and a user may control a virtual object to move in the virtual scene.
4) A virtual role is an image of various people and objects that can interact in a virtual scene, or a movable object in a virtual scene. The movable object may be a virtual person, a virtual animal, an animated person, or the like, for example, a person or an animal displayed in the virtual scene. The virtual role may be a virtual image that is in the virtual scene and that is configured for representing a user. The virtual scene may include a plurality of virtual roles, and each virtual role has a shape and a size in the virtual scene, and occupies some space in the virtual scene. The virtual role may alternatively be a game role controlled by a user (or referred to as a player).
5) A virtual equipment is a virtual article worn or held by a virtual role controlled by a target account (or a player), and one virtual role may wear or hold a plurality of virtual equipment. Each virtual equipment has equipment quality and an equipment attribute. The equipment attribute is further divided into a basic attribute and a special effect attribute. The equipment quality controls a maximum value of the basic attribute and a maximum quantity of special effect attributes of the virtual equipment. A virtual equipment with higher equipment quality corresponds to a larger maximum value of the basic attribute and a larger maximum quantity of special effect attributes. When the same virtual equipment has a plurality of special effect attributes with the same name, and a quantity of the special effect attributes reaches a threshold, parameters of the special effect attributes are multiplied (that is, a special effect kit is triggered).
6) An equipment synthesis function is a function of combining a target primary virtual equipment selected by a target account (or a player) from all virtual equipment (including a virtual equipment worn and held by a virtual role) and a target secondary virtual equipment selected from the held virtual equipment. After synthesis is completed, the target primary virtual equipment and the target secondary virtual equipment are eliminated, and a synthesized target virtual equipment is obtained. Equipment quality of the target virtual equipment is the same as equipment quality of the target primary virtual equipment, and a basic attribute and a special effect attribute of the target virtual equipment are obtained according to basic attributes and special effect attributes of the target primary virtual equipment and the target secondary virtual equipment.

Embodiments of this application provide a synthesis method and apparatus for a virtual equipment, an electronic device, a computer-readable storage medium, and a computer program product, which can improve synthetic randomness of a virtual equipment. The following describes an example application of an electronic device provided in an embodiment of this application. The electronic device provided in an embodiment of this application may be implemented as various types of user terminals such as a laptop computer, a tablet computer, a desktop computer, a set top box, a mobile device (for example, a mobile phone, a portable music player, a personal digital assistant, a dedicated messaging device, or a portable game device), a smartphone, a smart speaker, a smartwatch, a smart television, and an in-vehicle terminal, or may be implemented as a server. Certain applications are described below by using examples in which the device is implemented as a terminal.

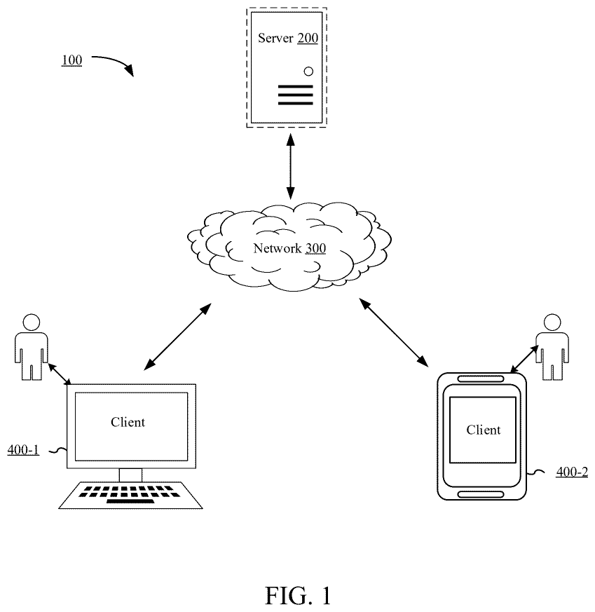

Referring to FIG. 1, FIG. 1 is a schematic architecture diagram of a synthesis system 100 for a virtual equipment according to an embodiment of this application. To support an example application, terminals (a terminal 400-1 and a terminal 400-2 are exemplarily shown) are connected to a server 200 through a network 300. The network 300 may be a wide area network, a local area network, or a combination thereof.

In some embodiments, the terminal may be a smartphone, a tablet computer, a notebook computer, a desktop computer, a smart speaker, a smart watch, an in-vehicle terminal, or the like, but is not limited thereto. The terminal is provided with a client having a live streaming function, such as a video playback client, an instant messaging client, a game client, or a live streaming client. The server 200 is a backend server corresponding to a client, and may be an independent physical server, or may be a server cluster or a distributed system formed by a plurality of physical servers, or may be a cloud server that provides basic cloud computing service such as a cloud service, a cloud database, cloud computing, a cloud function, cloud storage, a network service, cloud communication, a middleware service, a domain name service, a security service, a content distribution network (CDN), big data, and an artificial intelligence platform. The terminal and the server may be directly or indirectly connected in a wired or wireless communication manner, which is not limited in embodiments of this application.

In one embodiment, the terminal displays a synthesis interface of a virtual equipment, displays an equipment selection control in the synthesis interface, and transmits, in response to an equipment selection instruction triggered based on the equipment selection control, an equipment selection instruction to the server 200. The server 200 obtains, based on the equipment selection instruction, a target primary virtual equipment and a target secondary virtual equipment that are instructed by the equipment selection instruction to be selected, and returns the target primary virtual equipment and the target secondary virtual equipment to the terminal. The terminal displays the target primary virtual equipment and the target secondary virtual equipment in the synthesis interface. In response to an equipment synthesis instruction transmitted by a target account, the terminal displays, in the synthesis interface, a target virtual equipment synthesized by the target primary virtual equipment and the target secondary virtual equipment.

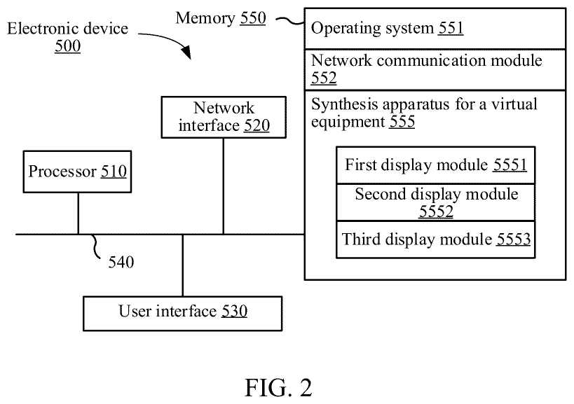

Referring to FIG. 2, FIG. 2 is a schematic structural diagram of an electronic device 500 according to an embodiment of this application. For example, an electronic device 500 is the terminal in FIG. 1. The electronic device 500 shown in FIG. 2 includes at least one processor 510, a memory 550, at least one network interface 520, and a user interface 530. Components in the electronic device 500 are coupled together by using a bus system 540. The bus system 540 is configured to implement connection and communication between the components. In addition to a data bus, the bus system 540 further includes a power bus, a control bus, and a status signal bus. However, for clear description, all types of buses in FIG. 2 are marked as the bus system 540.

The processor 510 may be an integrated circuit chip, and has a signal processing capability, for example, a general-purpose processor, a digital signal processor (DSP), another programmable logic device, a discrete gate or transistor logic device, or a discrete hardware component. The general-purpose processor may be a microprocessor or any conventional processor.

The memory 550 includes a volatile memory or a non-volatile memory, or may include both a volatile memory and a non-volatile memory. The non-volatile memory may be a read-only memory (ROM), and the volatile memory may be a random access memory (RAM). The memory 550 described in this embodiment of this application is intended to include any suitable type of memory. In some embodiments, the memory 550 includes one or more storage devices physically located away from the processor 510.

In some embodiments, the memory 550 can store data to support various operations, and examples of the data include programs, modules, and data structures, or subsets or supersets thereof, as illustrated below.

An operating system 551 includes a system program configured to process various basic system services and perform hardware-related tasks, for example, a framework layer, a kernel library layer, and a driver layer, and the operating system is configured to implement various basic services and process hardware-based tasks. A network communication module 552 is configured to reach another electronic device via one or more (wired or wireless) network interfaces 520. Network interfaces 520 include: Bluetooth, wireless compatibility authentication (Wi-Fi), a universal serial bus (USB), and the like.

In some embodiments, the synthesis apparatus for a virtual equipment provided in the embodiments of this application may be implemented in a software manner. The synthesis apparatus for a virtual equipment provided in the embodiments of this application may be provided as various software embodiments, including various forms such as an application program, software, a software module, a script, or code. FIG. 2 shows a synthesis apparatus 555 for a virtual equipment stored in the memory 550. The synthesis apparatus may be software in a form of a program, a plug-in, or the like, and includes a series of modules, including a first display module 5551, a second display module 5552, and a third display module 5553. These modules are logical. Therefore, any combination or further division may be performed according to an implemented function, and functions of each module are described below.

In some other embodiments, the apparatus provided in the embodiments of this application may be implemented in a hardware manner. As an example, the apparatus provided in the embodiments of this application may be a processor in the form of a hardware decoding processor. The processor is programmed to perform the synthesis method for a virtual equipment provided in the embodiments of this application. For example, the processor in the form of a hardware decoding processor may adopt one or more application-specific integrated circuits (ASIC), DSPs, PLDs, complex PLDs (CPLD), field-programmable gate arrays (FPGA), or other electronic elements.

In some embodiments, the terminal or the server may implement the synthesis method for a virtual equipment provided in embodiments of this application by running various computer-executable instructions or a computer program. For example, the computer-executable instructions may be a microprogram-level command, machine instructions, or software instructions. The computer program may be a native program or a software module in an operating system; may be a native application (APP), namely, a program that needs to be installed in an operating system to run, such as an instant messaging APP or a live streaming APP; or may be a mini program that may be embedded in any APP, namely, a program that only needs to be downloaded into a browser environment to run. To sum up, the computer-executable instructions may be instructions in any form, and the foregoing computer program may be an application program, a module, or a plug-in in any form.

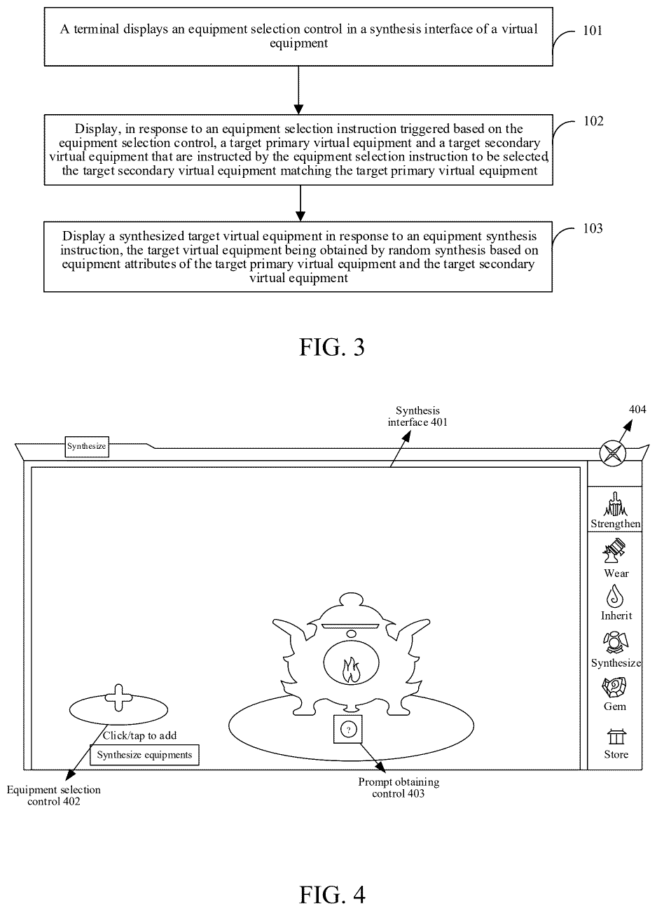

As described above, the synthesis method for a virtual equipment provided in the embodiment of this application may be implemented by various types of electronic devices, for example, may be performed by any one of the terminal and the server 200 in FIG. 1 alone, or may be performed by the terminal and the server 200 in FIG. 1 in cooperation. Next, an example in which the terminal in FIG. 1 performs the synthesis method for a virtual equipment alone provided in the embodiment of this application is configured for description. Referring to FIG. 3, FIG. 3 is a schematic flowchart of a synthesis method for a virtual equipment according to an embodiment of this application, and operations shown in FIG. 3 are combined for description.

Operation 101: A terminal displays an equipment selection control in a synthesis interface of a virtual equipment.

In some embodiments, a client supporting a virtual scene is installed on the terminal (for example, when the virtual scene is a game, the corresponding client may be a massively multiplayer online role-playing game APP). When a user opens the client on the terminal and the terminal runs the client, the terminal may display a virtual scene interface, and display, in the virtual scene interface, an equipment synthesis entry configured for invoking an equipment synthesis function. When the user triggers the equipment synthesis entry, the terminal displays a synthesis interface of the virtual equipment in response to the trigger operation, and displays an equipment selection control in the synthesis interface of the virtual equipment. The synthesis interface is configured for synthesizing virtual equipment. The equipment selection control is configured for selecting a primary virtual equipment and a secondary virtual equipment required for synthesizing the virtual equipment. In addition to the equipment selection control, the synthesis interface may further include a prompt obtaining control and an interface closing control.

For example, referring to FIG. 4, FIG. 4 is a schematic diagram of a synthesis interface of a virtual equipment according to this application. An equipment selection control 402 configured for selecting a sub virtual equipment required for synthesizing the virtual equipment is displayed in a synthesis interface 401 of a virtual scene. The sub virtual equipment is a synthesis element required for synthesizing the target virtual equipment, and includes a primary virtual equipment and a secondary virtual equipment. In addition, a prompt obtaining control 403 and an interface closing control 404 may further be displayed. The prompt obtaining control 403 is configured for obtaining related information of a synthesis rule of the virtual equipment. For example, when the user triggers the prompt obtaining control 403, the terminal may display a synthesis prompt interface in response to the trigger operation, and display, in the synthesis prompt interface, related information used by the user to learn about the synthesis rule of the virtual equipment. In addition, the user closes the synthesis interface of the virtual equipment by triggering the interface closing control 403, to return to play in an interaction picture of the virtual scene.

Operation 102: Display, in response to an equipment selection instruction triggered based on the equipment selection control, a target primary virtual equipment and a target secondary virtual equipment that are instructed by the equipment selection instruction to be selected, the target secondary virtual equipment matching the target primary virtual equipment.

In some embodiments, when the terminal receives an equipment selection instruction triggered based on the equipment selection control, in response to the equipment selection instruction, the terminal obtains data information (such as equipment quality and an equipment attribute) of the target primary virtual equipment and the target secondary virtual equipment that are instructed by the equipment selection instruction to be selected, and displays the target primary virtual equipment and the target secondary virtual equipment in the synthesis interface.

Herein, the target primary virtual equipment is a template unit for equipment synthesis, and the target secondary virtual equipment is a virtual equipment matching the target primary virtual equipment, and is equivalent to a raw material for equipment synthesis. That is, synthesis of the virtual equipment may be implemented by adding the equipment attribute of the target secondary virtual equipment to the target primary virtual equipment (that is, an equipment attribute of the target virtual equipment obtained through synthesis is higher than the equipment attribute of the original target primary virtual equipment). The matching may mean that an equipment location corresponding to the target secondary virtual equipment is the same as that corresponding to the target primary virtual equipment. For example, the target primary virtual equipment is a fighting garment equipped on a virtual role and the target secondary virtual equipment may be a button equipped to the fighting garment. The matching may alternatively mean that the target secondary virtual equipment and the target primary virtual equipment complement each other to form one organic integral virtual equipment. That is, the target secondary virtual equipment and the target primary virtual equipment may separately sub-components forming one organic integral virtual equipment. For example, the target primary virtual equipment is a firearm body in a virtual firearm, and the target secondary virtual equipment is a bullet equipped to the firearm body. Certainly, the target secondary virtual equipment and the target primary virtual equipment may alternatively be in another matching form. This is not limited in this application herein.

When the virtual equipment is synthesized, a player usually follows the following principle to select a primary virtual equipment and a secondary virtual equipment needed for synthesizing the virtual equipment: First, the primary virtual equipment is usually a virtual equipment that the player wants to retain a main attribute and feature thereof after the synthesis, and the primary virtual equipment is a core virtual equipment in a synthesis process, and other secondary virtual equipment are synthesized around the primary virtual equipment. The primary virtual equipment usually needs to meet specific quality and level requirements, to synthesize a virtual equipment of higher quality with other secondary virtual equipment. The quality and the levels of the primary virtual equipment and the secondary virtual equipment that are selected by the player need to match each other. In addition, the primary virtual equipment needs to have an attribute or a basic attribute most valued by the player, such as attack power, defense power, and health points. The secondary virtual equipment provides an additional attribute, skill, groove, or the like, which is configured for supplementing deficiency of the primary virtual equipment and improving overall strength of the synthesized virtual equipment. A quantity of secondary equipment is usually 3 to 4, and a specific quantity is determined according to different games and synthesis rules. When the secondary virtual equipment is selected, a virtual equipment that can supplement the primary virtual equipment needs to be selected. For example, a secondary virtual equipment having an additional groove can increase a quantity of grooves of the primary virtual equipment, and a secondary virtual equipment having a particular attribute can endow a new capability to the primary virtual equipment.

The primary virtual equipment and the secondary virtual equipment need to be selected according to a player's requirement and an equipment synthesis rule. That is, the player needs to select, according to an expected attribute and function of the target virtual equipment, suitable virtual equipment as the target primary virtual equipment and the target secondary virtual equipment that participate in equipment synthesis. For example, if the player hopes that the synthesized target virtual equipment has a specific attribute, the target primary virtual equipment selected by the player needs to have a basic attribute, and the target secondary virtual equipment needs to provide a missing attribute or enhance the basic attribute. For another example, if the synthesis target of the player is to increase the quantity of grooves of the virtual equipment, the player needs to select a target primary virtual equipment having a relatively small quantity of grooves and a target secondary virtual equipment having a relatively large quantity of grooves.

In some embodiments, when the equipment selection control includes a primary equipment selection control and a secondary equipment selection control, the terminal may respond, in the following manner, to an equipment selection instruction triggered based on the equipment selection control, to display a target primary virtual equipment and a target secondary virtual equipment instructed by the equipment selection instruction to be selected: displaying a primary equipment selection interface in response to a trigger operation for the primary equipment selection control, and displaying at least one candidate primary virtual equipment in the primary equipment selection interface, displaying, in response to an equipment selection instruction for a target primary virtual equipment of the at least one candidate primary virtual equipment, the target primary virtual equipment; displaying a secondary equipment selection interface in response to a trigger operation for the secondary equipment selection control, and displaying at least one candidate secondary virtual equipment in the secondary equipment selection interface, the candidate secondary virtual equipment matching the target primary virtual equipment; and displaying, in response to an equipment selection instruction for a target secondary virtual equipment of the at least one candidate secondary virtual equipment, the target secondary virtual equipment.

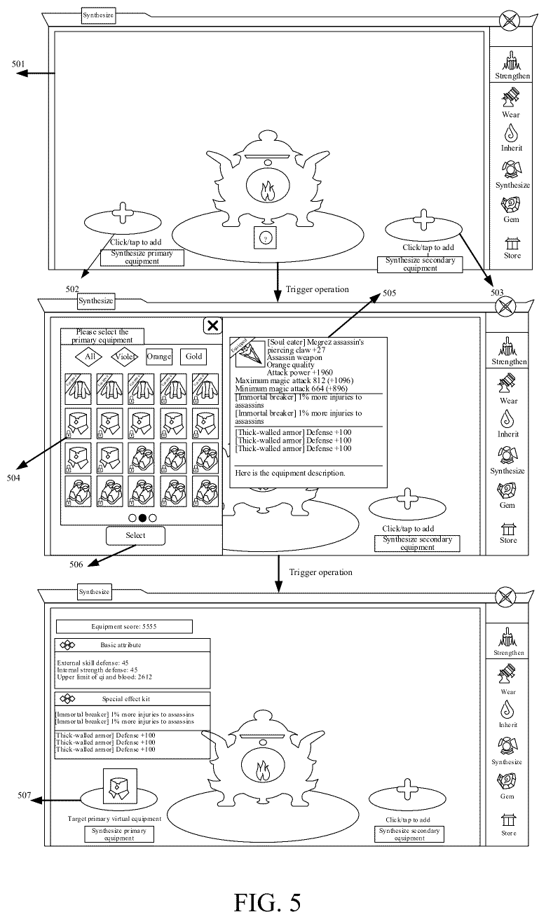

In one embodiment, equipment selection controls displayed in the synthesis interface may be divided into a primary equipment selection control and a secondary equipment selection control. The primary equipment selection control is configured for selecting a primary virtual equipment participating in equipment synthesis, and the secondary equipment selection control is configured for selecting a secondary virtual equipment participating in equipment synthesis. Referring to FIG. 5, FIG. 5 is a schematic display diagram of a synthesis interface of a virtual equipment according to an embodiment of this application. A terminal displays a primary equipment selection control 501 and a secondary equipment selection control 502 in a synthesis interface 501. When a user triggers the primary equipment selection control 502, the terminal displays a primary equipment selection interface 503, and displays a plurality of candidate primary virtual equipment 504 in the primary equipment selection interface 503. When the user triggers a candidate primary virtual equipment, an equipment details interface 505 of the candidate primary virtual equipment may be displayed, and equipment details information corresponding to the candidate primary virtual equipment, such as equipment quality and an equipment attribute (including a basic attribute and a special effect attribute), is displayed in the equipment details interface 504, so that the user determines, by viewing the equipment details information of the candidate primary virtual equipment, whether to select the candidate primary virtual equipment for equipment synthesis. When the user selects a target primary virtual equipment from a plurality of candidate primary virtual equipment (for example, a candidate primary virtual equipment is selected and a selection control 506 is triggered, and the selected candidate primary virtual equipment is the target primary virtual equipment), the terminal displays, in response to the selection operation, a selected target primary virtual equipment 507 and an equipment parameter, such as a basic attribute parameter and a special effect attribute parameter, corresponding to the target primary virtual equipment 507.

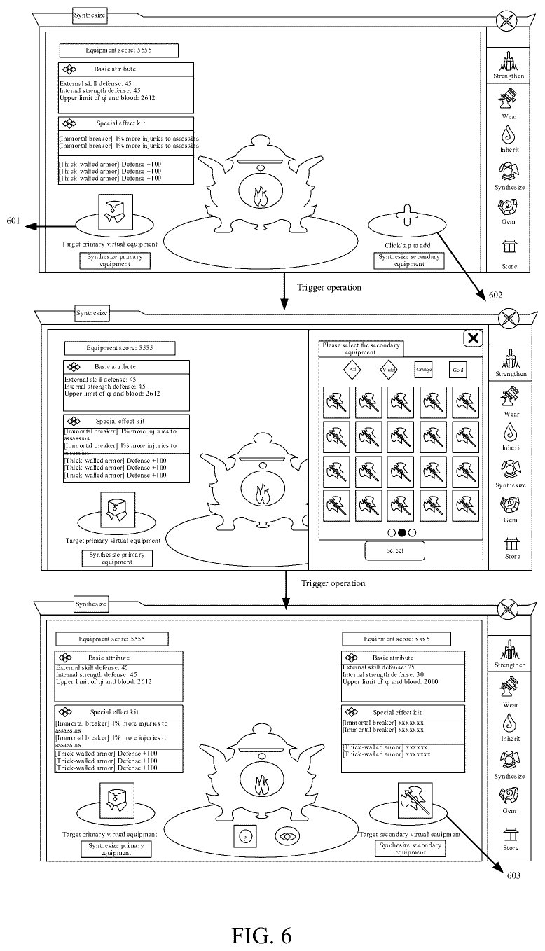

Referring to FIG. 6, FIG. 6 is a schematic display diagram of a synthesis interface of a virtual equipment according to an embodiment of this application. After a selected target primary virtual equipment 601 is determined, when a user triggers a secondary equipment selection control 602, a terminal displays a secondary equipment selection interface 603 in response to the trigger operation, and displays at least one candidate secondary virtual equipment matching the target primary virtual equipment in a secondary equipment selection interface 603. When the user selects a target secondary virtual equipment from a plurality of candidate secondary virtual equipment (for example, selects a candidate secondary virtual equipment and triggers a selection control, and the selected candidate secondary virtual equipment is a target secondary virtual equipment), the terminal displays a selected target secondary virtual equipment 603 in response to the selection operation, and an equipment parameter corresponding to the target secondary virtual equipment, such as a basic attribute parameter and a special effect attribute parameter.

In the foregoing manner, the player may select, by using the primary equipment selection control, the target primary virtual equipment required for equipment synthesis, and when the secondary equipment selection control is triggered after the target primary virtual equipment is determined, only the candidate secondary virtual equipment matching the target primary virtual equipment is displayed. Compared with displaying all candidate secondary virtual equipment, the difficulty of selecting the secondary virtual equipment matching the target primary virtual equipment is reduced, and efficiency and accuracy of equipment selection are improved.

In some embodiments, the terminal may display the at least one candidate secondary virtual equipment in the secondary equipment selection interface in the following manner: when there are at least two candidate secondary virtual equipment, obtaining an influencing parameter configured for influencing a selection priority of each candidate secondary virtual equipment, the influencing parameter including at least one of the following: an adaptation degree between the candidate secondary virtual equipment and the target primary virtual equipment, an equipment attribute feature of the candidate secondary virtual equipment, and a historical selection rate corresponding to the candidate secondary virtual equipment; invoking a neural network model to perform priority prediction based on the influencing parameter, to obtain the selection priority of each candidate secondary virtual equipment; and displaying each candidate secondary virtual equipment in the secondary equipment selection interface in a display style corresponding to each selection priority.

Herein, when there are at least two candidate secondary virtual equipment, selection priorities corresponding to different candidate secondary virtual equipment may be different, and each candidate secondary virtual equipment may be displayed in a corresponding display style according to the selection priority corresponding to the candidate secondary virtual equipment. That is, each candidate secondary virtual equipment is displayed in a different display style (for example, a different display order, a different display color, different display brightness, or a different display font) for candidate secondary virtual equipment with different selection priorities, or a candidate secondary virtual equipment with a higher selection priority is highlighted. For example, there may be two candidate secondary virtual equipment for selection, that is, a candidate secondary virtual equipment 1 and a candidate secondary virtual equipment 2. Selection priorities corresponding to the two candidate secondary virtual equipment sequentially decrease. The candidate secondary virtual equipment 1 may be displayed in a red contour style, and the candidate secondary virtual equipment 2 may be displayed in a gray contour style, so that the user selects the needed candidate secondary virtual equipment as the target secondary virtual equipment, thereby facilitating improving pertinence and efficiency of selecting the target secondary virtual equipment.

In one embodiment, when the selection priority of the candidate secondary virtual equipment is determined, when the influencing parameter includes the adaptation degree between the candidate secondary virtual equipment and the target primary virtual equipment (where the adaptation degree may be determined by calculating a similarity between a feature of the candidate secondary virtual equipment and a feature of the target primary virtual equipment, and the feature includes, but is not limited to, an attribute, a skill, quality, and a level), usually, when the adaptation degree between the candidate secondary virtual equipment and the target primary virtual equipment exceeds an adaptation degree threshold (which may be set according to specific requirements, for example, set to 80%), it is considered that the candidate secondary virtual equipment matches the target primary virtual equipment. When the candidate secondary virtual equipment matches the target primary virtual equipment, the adaptation degree and the selection priority of the candidate secondary virtual equipment are in a positive correlation. For example, a larger adaptation degree between the candidate secondary virtual equipment and the target primary virtual equipment indicates a higher corresponding selection priority of the candidate secondary virtual equipment. When the influencing parameter includes the equipment attribute feature of the candidate secondary virtual equipment, the equipment attribute feature includes a basic attribute feature and a special effect attribute feature, and an equipment attribute capability of the candidate secondary virtual equipment may be determined based on the equipment attribute feature. Usually, the selection priority of the candidate secondary virtual equipment has a positive correlation with the equipment attribute capability of the candidate secondary virtual equipment. For example, a stronger equipment attribute capability of the candidate secondary virtual equipment indicates a higher corresponding selection priority. When the influencing parameter includes the historical selection rate corresponding to the candidate secondary virtual equipment, the historical selection rate may be a probability that a current account or another account different from the current account selects the candidate secondary virtual equipment after selecting the target primary virtual equipment. Usually, the selection priority of the candidate secondary virtual equipment has a positive correlation with the historical selection rate of the candidate secondary virtual equipment. For example, a higher historical selection rate corresponding to the candidate secondary virtual equipment indicates a higher selection priority corresponding to the candidate secondary virtual equipment. After the influencing parameter configured for influencing the selection priority of the candidate secondary virtual equipment is obtained, prediction processing is performed in the neural network model trained with the influencing parameter, to obtain the selection priority of the candidate secondary virtual equipment, so that prediction can be more accurate.

Before the neural network model is applied, an initial neural network model needs to be trained, and then the trained neural network model is put into application, to predict the selection priority of the candidate secondary virtual equipment by using an artificial intelligence technology with reference to the influencing parameter. The neural network model is obtained through training by using a secondary virtual equipment sample, an influencing parameter corresponding to the secondary virtual equipment sample, and a selection priority marked for the secondary virtual equipment sample. For example, an initial neural network model is invoked to perform prediction processing based on a secondary virtual equipment sample, a historical selection rate associated with the secondary virtual equipment sample, and a selection priority marked for the secondary virtual equipment sample, to obtain a predicted selection priority. After a value of a loss function of the neural network model is determined by using the predicted selection priority and the marked selection priority, whether the value of the loss function exceeds a preset threshold may be determined. When the value of the loss function exceeds the preset threshold, an error signal of the neural network model is determined based on the loss function, The error signal is back propagated in the neural network model, and a model parameter of each layer is updated in a propagation process.

A model structure of the neural network model is not limited in this embodiment of this application. For example, the neural network model may be a convolutional neural network, a deep neural network, or the like. A form of the loss function is not limited. For example, the loss function may be a cross-entropy loss function or an L2 loss function.

Herein, back propagation is described. Training sample data is input to an input layer of the neural network model, passes through a hidden layer, and finally reaches an output layer and a result is output. This is a forward propagation process of the neural network model. Because there is an error between the output result and the result of the neural network model, an error between the output result and an actual value is calculated, and the error is back propagated from the output layer to the hidden layer until the error is propagated to the input layer. In the back propagation process, the value of the model parameter is adjusted according to the error, that is, a loss function is constructed according to the error between the output result and the actual value, and a partial derivative of the loss function for the model parameter is solved layer by layer. A gradient of the loss function for each layer of the model parameter is generated. Because a direction of the gradient indicates a direction of error expansion, the gradient of the model parameter is negated, and summed with an original parameter of each layer of the model. An obtained summation result is used as an updated model parameter of each layer, to reduce an error caused by the model parameter. The foregoing process is continuously iterated until convergence is achieved.

In some embodiments, the terminal may update the candidate primary virtual equipment or the candidate secondary virtual equipment in the following manner: displaying an equipment update entry in a primary equipment selection interface or a secondary equipment selection interface, where the equipment update entry is configured for updating at least one candidate primary virtual equipment in the primary equipment selection interface, or configured for updating at least one candidate secondary virtual equipment in the secondary equipment selection interface.

In some embodiments, in view of a limited display area of the primary equipment selection interface or the secondary equipment selection interface, when there are a relatively large quantity of candidate primary virtual equipment or candidate secondary virtual equipment, and consequently, not all candidate primary virtual equipment can be displayed in the primary equipment selection interface or not all candidate secondary virtual equipment can be displayed in the secondary equipment selection interface, some candidate primary virtual equipment may be displayed in the primary equipment selection interface or some candidate secondary virtual equipment may be displayed in the secondary equipment selection interface. In this case, an equipment update entry may be displayed in the primary equipment selection interface or the secondary equipment selection interface. Content currently displayed in the primary equipment selection interface or the secondary equipment selection interface is updated by using the equipment update entry. That is, when a plurality of candidate primary virtual equipment are displayed in the primary equipment selection interface, the plurality of candidate primary virtual equipment currently displayed in the primary equipment selection interface may be replaced by using the equipment update entry. When a plurality of candidate secondary virtual equipment are displayed in the secondary equipment selection interface, the plurality of candidate secondary virtual equipment currently displayed in the secondary equipment selection interface may be replaced by using the equipment update entry. A representation form of the equipment update entry includes, but is not limited to: an update key (for example, an update control), update prompt information (for example, “refresh batch”), and a page-turn symbol. For example, in FIG. 5, the primary equipment selection interface may be slid based on a page-turn symbol, and a similar “page-turn” operation is performed on a plurality of displayed candidate primary virtual equipment, to implement updated display of the candidate primary virtual equipment. Accordingly, the user may select a corresponding candidate primary virtual equipment or candidate secondary virtual equipment according to a specific requirement for equipment synthesis, which can improve flexibility and applicability of equipment synthesis.

In some embodiments, the terminal may respond, in the following manner, to an equipment selection instruction triggered based on an equipment selection control, to display a target primary virtual equipment and a target secondary virtual equipment instructed by the equipment selection instruction to be selected: displaying an equipment selection interface in response to a trigger operation for the equipment selection control, the equipment selection interface including a primary equipment selection area and a secondary equipment selection area, and the primary equipment selection area including at least one candidate primary virtual equipment; displaying, in response to an equipment selection instruction for a target primary virtual equipment of at least one candidate primary virtual equipment, the target primary virtual equipment; and displaying, based on the target primary virtual equipment in response to an equipment selection instruction triggered in the secondary equipment selection area, a target secondary virtual equipment instructed by the equipment selection instruction to be selected.

In some embodiments, when there is only one equipment selection control displayed in the synthesis interface of the virtual equipment, the terminal displays an equipment selection interface in response to a trigger operation for the equipment selection control, and displays a primary equipment selection area (configured for selecting a primary virtual equipment) and a secondary equipment selection area (configured for selecting a secondary virtual equipment) in the equipment selection interface. The primary equipment selection area displays at least one candidate primary virtual equipment. When the user selects a target primary virtual equipment therefrom, the terminal displays the selected target primary virtual equipment in response to the selection operation, and further triggers a corresponding equipment selection instruction in the secondary equipment selection area based on the selected target primary virtual equipment, to display, in the secondary equipment selection area, the target secondary virtual equipment instructed by the equipment selection instruction to be selected.

In some embodiments, the terminal may respond, in the following manner, to an equipment selection instruction triggered in the secondary equipment selection area, to display the target secondary virtual equipment instructed by the equipment selection instruction to be selected: displaying at least one candidate secondary virtual equipment in the secondary equipment selection area, the candidate secondary virtual equipment matching the target primary virtual equipment; and displaying, in response to an equipment selection instruction for a target secondary virtual equipment of the at least one candidate secondary virtual equipment, the target secondary virtual equipment.

In some embodiments, after the user selects and determines the target primary virtual equipment in the primary equipment selection area, that is, after the terminal displays the target primary virtual equipment in response to the equipment selection instruction for the target primary virtual equipment of the at least one candidate primary virtual equipment, the at least one candidate secondary virtual equipment matching the target primary virtual equipment may be directly displayed in the secondary equipment selection area, for the user to select and determine the target secondary virtual equipment therefrom.

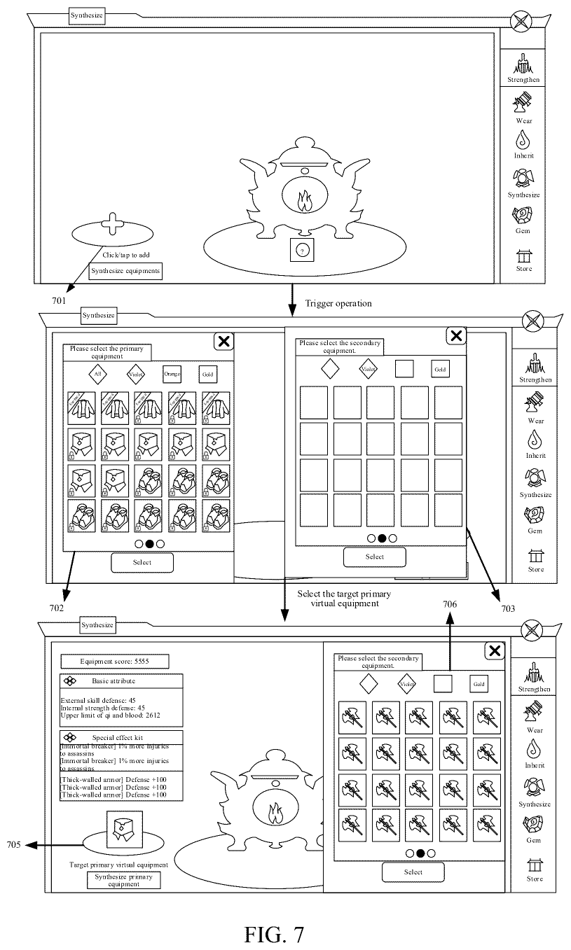

Referring to FIG. 7, FIG. 7 is a schematic display diagram of a synthesis interface of a virtual equipment according to an embodiment of this application. When there is only one equipment selection control displayed in the synthesis interface of the virtual equipment, a terminal displays an equipment selection interface in response to a trigger operation for an equipment selection control 701, and displays a primary equipment selection area 702 and a secondary equipment selection area 703 in the equipment selection interface. The primary equipment selection area 702 displays at least one candidate primary virtual equipment. Before the user selects the target primary virtual equipment from the primary equipment selection area 702, the secondary equipment selection area 703 may not display candidate secondary virtual equipment. After the user selects the target primary virtual equipment from the primary equipment selection area, the terminal responds to the selection operation, displays the selected target primary virtual equipment 705 in the primary equipment selection area 702, and displays at least one candidate secondary virtual equipment 706 matching the target primary virtual equipment in a secondary equipment selection area 704. When the user selects the target secondary virtual equipment (the selection operation can trigger the equipment selection instruction), the terminal displays the selected target secondary virtual equipment in response to the selection operation (that is, the equipment selection instruction).

In the foregoing manner, after selecting and determining the target primary virtual equipment, the player displays only the candidate secondary virtual equipment matching the target primary virtual equipment in the secondary equipment selection area. Compared with displaying all candidate secondary virtual equipment, the difficulty of selecting the secondary virtual equipment matching the target primary virtual equipment is reduced, and efficiency and accuracy of equipment selection are improved.

In some embodiments, before the player selects the target primary virtual equipment from the primary equipment selection area, at least one candidate secondary virtual equipment may also be displayed in the secondary equipment selection area. However, to prevent the player from directly selecting the target secondary virtual equipment in the secondary equipment selection area without determining the target primary virtual equipment, selection rejection prompt information may be displayed when an equipment selection instruction for the candidate secondary virtual equipment is received, to prompt to reject to trigger selection of the secondary virtual equipment in the secondary equipment selection area before determining the target primary virtual equipment. Accordingly, selection of the secondary virtual equipment not matching the target primary virtual equipment can be avoided, thereby improving pertinence of equipment selection.

In addition, before the player selects the target primary virtual equipment from the primary equipment selection area, a plurality of candidate secondary virtual equipment owned by the player may be displayed in the secondary equipment selection area, and after the player selects and determines the target primary virtual equipment, the secondary virtual equipment matching the target primary virtual equipment is selected from the plurality of candidate secondary virtual equipment owned by the player, and the candidate secondary virtual equipment displayed in the secondary equipment selection area is updated. For example, displaying all secondary virtual equipment owned by the player is updated to only displaying some secondary virtual equipment matching the target primary virtual equipment. Accordingly, compared with displaying all candidate secondary virtual equipment, the difficulty of selecting the secondary virtual equipment matching the target primary virtual equipment is reduced, and efficiency and accuracy of equipment selection are improved.

In some embodiments, before displaying the target primary virtual equipment, the terminal may display the candidate secondary virtual equipment in the following manner: displaying at least two candidate secondary virtual equipment in the secondary equipment selection area in a first display style. In this case, in response to an equipment selection instruction triggered in the secondary equipment selection area, the terminal may display, in the following manner, the target secondary virtual equipment instructed by the equipment selection instruction to be selected: displaying a first part of candidate secondary virtual equipment in the at least two candidate secondary virtual equipment in a second display style in the secondary equipment selection area, and displaying a second part of candidate secondary virtual equipment in the at least two candidate secondary virtual equipment in a third display style, where the second display style is configured for indicating that the first part of candidate secondary virtual equipment matches the target primary virtual equipment, and the third display style is configured for indicating that the second part of candidate secondary virtual equipment does not match the target primary virtual equipment; and in response to an equipment selection instruction for a target secondary virtual equipment in the first part of candidate secondary virtual equipment, displaying the target secondary virtual equipment.

In some embodiments, before the user selects the target primary virtual equipment from the primary equipment selection area, that is, before the terminal displays the target primary virtual equipment selected by the user, a plurality of (two or more) candidate secondary virtual equipment may further be directly displayed in the secondary equipment selection area in the first display style. However, after the user selects the target primary virtual equipment from the primary equipment selection area, that is, after the terminal displays the target primary virtual equipment selected by the user, the terminal separately matches the target primary virtual equipment against the plurality of candidate secondary virtual equipment in the secondary equipment selection area, for example, performs feature extraction on the target primary virtual equipment and each candidate secondary virtual equipment in the secondary equipment selection area, obtains a corresponding primary equipment feature and secondary equipment feature, calculates a similarity (for example, a cosine similarity) between the primary equipment feature and each secondary equipment feature, uses a calculated similarity value as a matching result, selects, according to the matching result, a first part of candidate secondary virtual equipment matching the target primary virtual equipment and a second part of candidate secondary virtual equipment not matching the target primary virtual equipment, and differently displays the candidate secondary virtual equipment. For example, the first part of candidate secondary virtual equipment is displayed in the second display style, and the second part of candidate secondary virtual equipment is displayed in the third display style in the secondary equipment selection area.

The first display style may be the same as or different from the second display style, or the first display style may be the same as or different from the third display style, but the second display style and the third display style are always different. For example, when the second display style is the same as the first display style, both the second display style and the third display style may be a highlight display style. For example, before displaying the target primary virtual equipment selected by the user, the terminal displays the plurality of candidate secondary virtual equipment in the secondary equipment selection area in the highlight display style (that is, the first display style), and after displaying the target primary virtual equipment selected by the user, the first part of candidate secondary virtual equipment matching the target primary virtual equipment is displayed in a highlight display style (that is, the second display style). In this case, the third display style is different from the first display style. For example, the second part of candidate secondary virtual equipment not matching the target primary virtual equipment is displayed in a grayscale display style (that is, the third display style). When the second display style is different from the first display style, for example, before displaying the target primary virtual equipment selected by the user, the terminal displays the plurality of candidate secondary virtual equipment in the secondary equipment selection area in a normal brightness style (that is, the first display style), and after displaying the target primary virtual equipment selected by the user, the terminal displays the first part of candidate secondary virtual equipment matching the target primary virtual equipment in a highlight display style (that is, the second display style, where display brightness indicated by the second display style is higher than display brightness indicated by the first display style). The third display style may be the same as the first reality style. That is, the second part of candidate secondary virtual equipment not matching the target primary virtual equipment is displayed in a normal brightness style. The third display style may alternatively be different from the first display style. For example, the second part of candidate secondary virtual equipment not matching the target primary virtual equipment is displayed in a grayscale display style.

In the foregoing manner, different display styles are configured for displaying candidate secondary virtual equipment matching or not matching the target primary virtual equipment, so that the user quickly selects the candidate secondary virtual equipment matching the target primary virtual equipment for equipment synthesis, thereby facilitating improving equipment selection efficiency, and further improving equipment synthesis efficiency.

In some embodiments, the terminal may display selection prompt information in response to a selection operation for the candidate secondary virtual equipment in the second part of candidate secondary virtual equipment. The selection prompt information is configured for prompting to reject selection of a candidate secondary virtual equipment not matching the target primary virtual equipment, or configured for prompting to reselect a candidate secondary virtual equipment matching the target primary virtual equipment.

In some embodiments, to ensure that the user correctly selects the candidate secondary virtual equipment matching the target primary virtual equipment, when the user selects the candidate secondary virtual equipment not matching the target primary virtual equipment, selection prompt information configured for prompting to reject selection of the candidate secondary virtual equipment not matching the target primary virtual equipment is displayed in the terminal, or selection prompt information configured for prompting the user to reselect the candidate secondary virtual equipment matching the target primary virtual equipment is displayed. Accordingly, pertinence and accuracy of selection of the secondary virtual equipment can be improved.

To avoid incorrect selection by the player, the second display style may further indicate that the first part of candidate secondary virtual equipment is in a selectable state, and the third display style may further indicate that the second part of candidate secondary virtual equipment is in a non-selectable state. The player may select only the target secondary virtual equipment from the first part of candidate secondary virtual equipment in the selectable state. When the player selects the secondary virtual equipment from the second part of candidate secondary virtual equipment in the non-selectable state, the terminal makes no response, or pops up selection prompt information, to prompt to reject selection of the candidate secondary virtual equipment not matching the target primary virtual equipment. The user is prompted to reselect the candidate secondary virtual equipment matching the target primary virtual equipment, so that pertinence and accuracy of selection of the secondary virtual equipment can be improved.

Operation 103: Display a synthesized target virtual equipment in response to an equipment synthesis instruction, the target virtual equipment being obtained by random synthesis based on equipment attributes of the target primary virtual equipment and the target secondary virtual equipment.

In some embodiments, when receiving an equipment synthesis instruction, the terminal randomly synthesizes a target virtual equipment according to equipment attributes of the target primary virtual equipment and the target secondary virtual equipment in response to the equipment synthesis instruction, and displays the synthesized target virtual equipment.

In some embodiments, before displaying the synthesized target virtual equipment in response to the equipment synthesis instruction, the terminal may preview a synthesis result of the virtual equipment in the following manner: displaying a synthesis preview control; and displaying a synthesis preview interface in response to a trigger operation for the synthesis preview control, and displaying, in the synthesis preview interface, an equipment attribute range of a preview virtual equipment synthesized based on the target primary virtual equipment and the target secondary virtual equipment; the equipment attribute range including at least one of the following: a basic attribute range and a special effect attribute range, configured for reference to determine whether to trigger the equipment synthesis instruction.

In some embodiments, the synthesis preview control may be displayed only after the user determines the target primary virtual equipment and the target secondary virtual equipment, or may be displayed before the user determines the target primary virtual equipment and the target secondary virtual equipment.

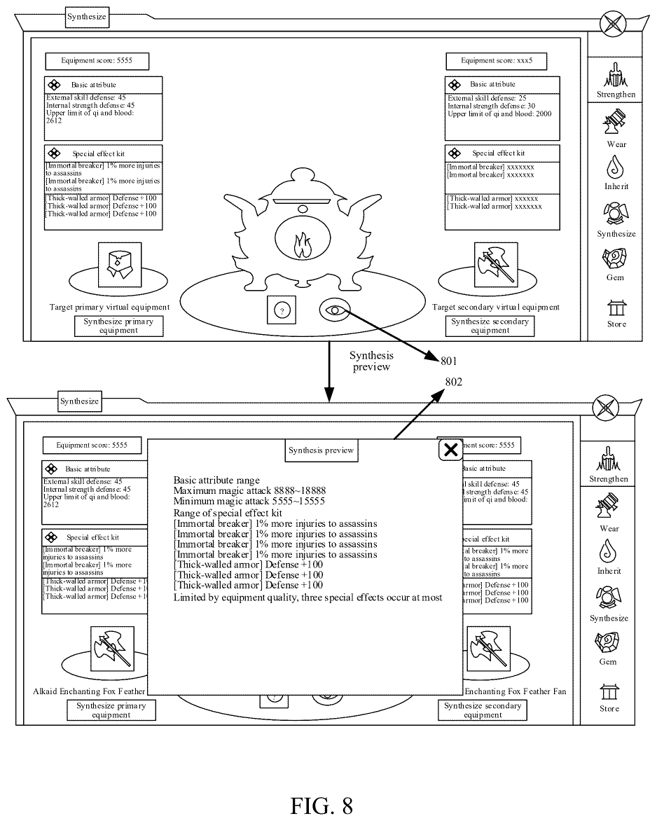

Referring to FIG. 8, FIG. 8 is a schematic display diagram of a synthesis preview interface of a virtual equipment according to an embodiment of this application. Using an example in which a synthesis preview control is displayed after a target primary virtual equipment and a target secondary virtual equipment are determined, a terminal displays a synthesis preview interface 802 in response to a trigger operation for a synthesis preview control 801, and displays, in the synthesis preview interface 802, an equipment attribute range, such as a basic attribute range and a special effect attribute range, of a preview virtual equipment synthesized based on the target primary virtual equipment and the target secondary virtual equipment. The basic attribute range of the preview virtual equipment is obtained by random combination according to basic attributes of the target primary virtual equipment and the target secondary virtual equipment. The special effect attribute range of the preview virtual equipment is obtained by random combination according to special effect attributes of the target primary virtual equipment and the target secondary virtual equipment.

A maximum basic attribute value (upper limit) of the basic attribute range of the preview virtual equipment is higher than a basic attribute value of any one of the target primary virtual equipment and the target secondary virtual equipment, and a minimum basic attribute value (lower limit) of the basic attribute range of the preview virtual equipment is not lower than a basic attribute value of any one of the target primary virtual equipment and the target secondary virtual equipment. For example, if the basic attribute value of the target primary virtual equipment is A and the basic attribute value of the target secondary virtual equipment is B, the maximum basic attribute value of the basic attribute range of the synthesized target virtual equipment may be (1+c %)*A, or (1+c %)*B, where c % is an increment amplitude, and may be set according to specific requirements, for example, 5%. Similarly, a maximum special effect attribute value (upper limit) of the special effect attribute range of the preview virtual equipment is higher than a special effect attribute value of any one of the target primary virtual equipment and the target secondary virtual equipment, and a minimum special effect attribute value (lower limit) of the special effect attribute range of the preview virtual equipment is higher than a special effect attribute value of any one of the target primary virtual equipment and the target secondary virtual equipment.

In the foregoing manner, by viewing the basic attribute range and the special effect attribute range of the preview virtual equipment, the user may predict the basic attribute range and the special effect attribute range of the synthesized target virtual equipment, and then determine whether to continue to synthesize the target virtual equipment. When the user determines to continue synthesizing the target virtual equipment, the user may trigger a corresponding equipment synthesis instruction. When the user is not satisfied with the currently synthesized preview virtual equipment, the user may reselect the target primary virtual equipment and the target secondary virtual equipment that are configured for equipment synthesis. Accordingly, pertinence and accuracy of equipment synthesis can be improved.

In some embodiments, the terminal may further display, in a synthesis preview interface, an equipment field guide entry for the preview virtual equipment, display an equipment field guide display interface in response to a trigger operation for the equipment field guide entry, and display, in the equipment field guide display interface, an equipment field guide of the preview virtual equipment.

The equipment field guide entry is configured for displaying an equipment field guide of a preview virtual equipment. The equipment field guide is a function in a virtual scene and may enable a user to see a virtual equipment already owned by the user, a source and an equipment attribute of a virtual equipment not yet owned by the user, and may help the user understand which virtual equipment still need to be collected or synthesized, and how to collect or synthesize virtual equipment. The equipment field guide may be classified according to different equipment quality and equipment levels. Generally, the higher the equipment quality, the better the equipment attribute, and the higher the equipment level, the higher the adapted virtual role level.

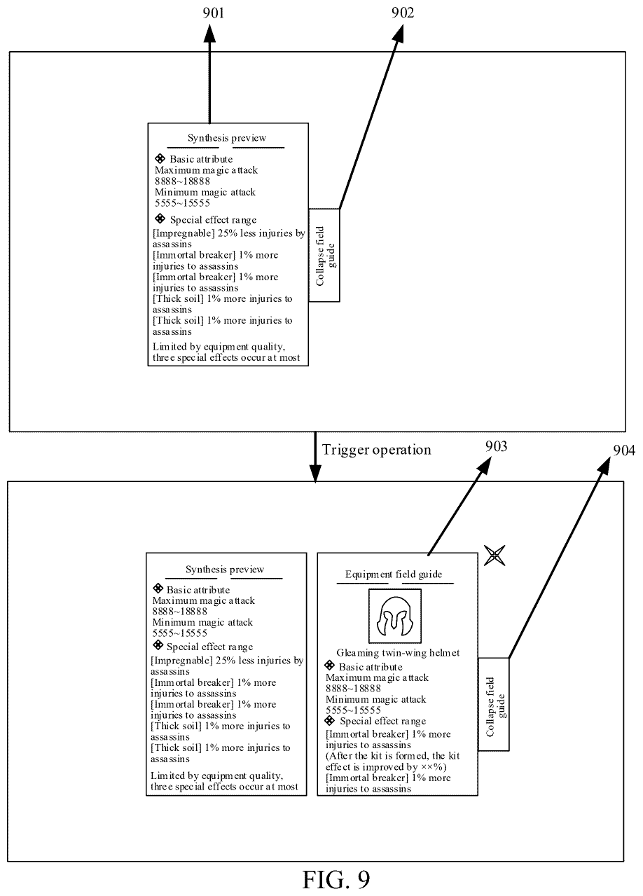

Referring to FIG. 9, FIG. 9 is a schematic display diagram of an equipment field guide according to an embodiment of this application. A terminal displays, in a synthesis preview interface 901, an equipment field guide entry 902 for a preview virtual equipment, displays, in response to a trigger operation for the equipment field guide entry 902, an equipment field guide interface 903, displays an equipment field guide of the preview virtual equipment in the equipment field guide interface 903, and may collapse the equipment field guide by using an equipment field guide control 904. The equipment field guide may include an extreme basic attribute and an extreme special effect attribute. The extreme basic attribute is a maximum value of a basic attribute range (that is, a maximum basic attribute value) of the preview virtual equipment, and the extreme special effect attribute is a maximum value of a special effect attribute range (that is, a maximum special effect attribute value) of the preview virtual equipment.

In the foregoing manner, by viewing the equipment field guide of the preview virtual equipment, the user may preview the maximum basic attribute value and the maximum special effect attribute value of the synthesized target virtual equipment, and then determine whether to continue to synthesize the target virtual equipment. When the user determines to continue synthesizing the target virtual equipment, the user may trigger a corresponding equipment synthesis instruction. When the user is not satisfied with the currently synthesized preview virtual equipment, the user may reselect the target primary virtual equipment and the target secondary virtual equipment that are configured for equipment synthesis. Accordingly, pertinence and accuracy of equipment synthesis can be improved.

In some embodiments, the synthesized target virtual equipment may be displayed in response to the equipment synthesis instruction in the following manner: displaying an equipment synthesis control; and displaying a synthesis result interface in response to an equipment synthesis instruction triggered based on the equipment synthesis control, and displaying a target virtual equipment and an equipment parameter of the target virtual equipment in the synthesis result interface.

Herein, the equipment synthesis control may be displayed only after the user determines the target primary virtual equipment and the target secondary virtual equipment, or may be displayed in the synthesis interface from the beginning.

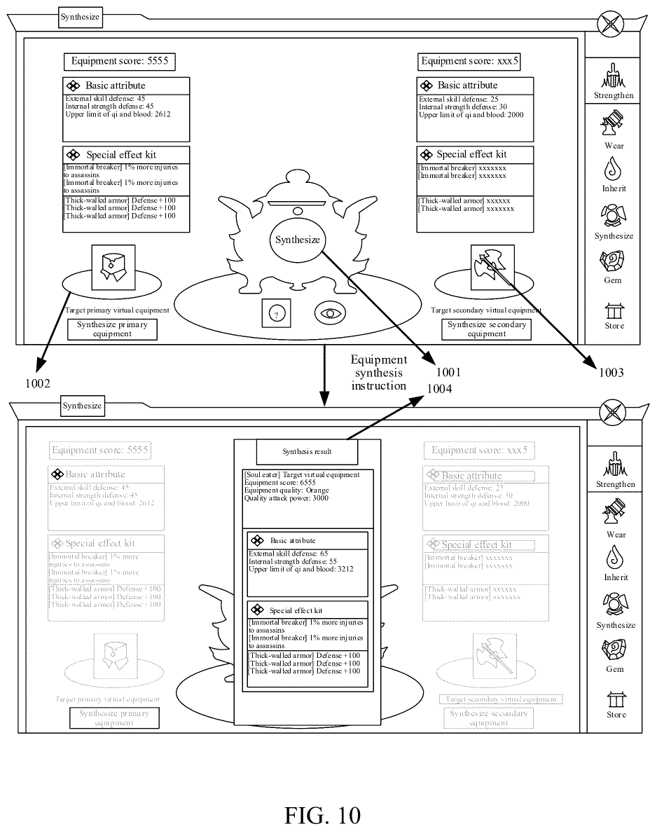

Referring to FIG. 10, FIG. 10 is a schematic diagram of a synthesis result of a virtual equipment according to an embodiment of this application. For example, an equipment synthesis control is displayed after a target primary virtual equipment and a target secondary virtual equipment are determined. After a selected target primary virtual equipment 1002 and target secondary virtual equipment 1003 are displayed in a synthesis interface of the equipment, an equipment synthesis control 1001 is further displayed. In response to an equipment synthesis instruction triggered for the equipment synthesis control 1001, a synthesis result page 1004 is displayed, and a synthesized target virtual equipment and a basic attribute parameter and a special effect attribute parameter of the target virtual equipment are displayed on the synthesis result page 1004.

The equipment parameter of the target virtual equipment includes a basic attribute parameter and a special effect attribute parameter. The equipment parameter of the target virtual equipment is obtained by randomly combining the equipment parameter of the target primary virtual equipment with the equipment parameter of the target secondary virtual equipment. For example, synthesis is performed according to a basic attribute value of the basic equipment parameter of the target primary virtual equipment and a basic attribute value of the basic equipment parameter of the target secondary virtual equipment, to obtain a basic attribute value of the basic attribute parameter of the target virtual equipment.

For example, the terminal may determine the basic attribute value of the target virtual equipment in the following manner: in response to an equipment synthesis instruction, separately obtaining a basic attribute value of the target primary virtual equipment and a basic attribute value of the target secondary virtual equipment, using a basic attribute value having a lower value as a first basic attribute value, a basic attribute value having a higher value as a second basic attribute value, and randomly selecting one value within the range of the first basic attribute and the second basic attribute as the basic attribute value of the target virtual equipment. Alternatively, when the first basic attribute value and the second basic attribute value are obtained, the first basic attribute value and the second basic attribute value may be further improved based on the obtained first basic attribute value and second basic attribute value. For example, an attribute value obtained by multiplying a basic attribute value with a relatively large value by an increment amplitude (greater than 1) is used as the basic attribute value of the target virtual equipment, so that a basic attribute of the target virtual equipment after synthesis can be more probably improved, thereby improving enthusiasm of synthesizing the virtual equipment by the user.

Similarly, the terminal may perform synthesis according to the special effect attribute parameter of the target primary virtual equipment and the special effect attribute parameter of the target secondary virtual equipment, to obtain the special effect attribute parameter of the target virtual equipment. For example, the terminal may obtain the special effect attribute of the target virtual equipment in the following manner: sequentially obtaining all special effect attributes of the target primary virtual equipment and all special effect attributes of the target secondary virtual equipment in response to the equipment synthesis instruction, and sorting all the special effect attributes of the target primary virtual equipment and all the special effect attributes of the target secondary virtual equipment, for example, according to a descending order of attribute strength (special effect attribute values) of the special effect attributes, sorting all the special effect attributes of the target primary virtual equipment and all the special effect attributes of the target secondary virtual equipment, to obtain a special effect attribute sequence; traversing the special effect attribute sequence to randomly select a particular quantity of special effect attributes; reserving the selected special effect attributes to a synthesized target virtual equipment, where each special effect attribute has the same probability (which may be set according to specific requirements, for example, set to 40%) of being reserved; and when it is determined that a quantity of the reserved special effect attributes reaches a maximum quantity of special effects corresponding to equipment quality of the target virtual equipment, stopping the process. The equipment quality of the target virtual equipment reserves the equipment quality of the target primary virtual equipment. The equipment quality affects a quantity of special effect attributes. For example, higher equipment quality corresponds to more special effect attributes.

In addition, a particular quantity of special effect attributes may be randomly selected from the special effect attribute of the target primary virtual equipment and the special effect attribute of the target secondary virtual equipment, to synthesize the target virtual equipment. For example, the target primary virtual equipment has N (a positive integer, which may be set according to specific requirements, for example, N is 3), and the target secondary virtual equipment has M (a positive integer, which may be set according to specific requirements, for example, M is 2), n (a positive integer not exceeding N) special effect attributes may be randomly selected from the N special effect attributes, and m (a positive integer not exceeding M) special effect attributes may be randomly selected from the M special effect attributes for random combination, so that an obtained target virtual equipment has (n+m) special effect attributes. Moreover, for each of the (n+m) special effect attributes of the target virtual equipment, a special effect attribute value of each special effect attribute may be reserved, or some degree of positive gain processing (for example, multiplying by a gain parameter greater than 1) or negative gain processing (for example, multiplying by a gain parameter less than 1) may be performed on the special effect attribute value of each special effect attribute, thereby increasing randomness of synthesizing the virtual equipment.

In some embodiments, the target virtual equipment and the equipment parameter of the target virtual equipment may be displayed in the synthesis result interface in the following manner: displaying an erasable coating in an associated area of the equipment parameter in the synthesis result interface, and gradually uncovering, in response to an erase operation for the erasable coating, an equipment parameter blocked by the erasable coating in the associated area; or displaying a one-click/tap uncover control in the synthesis result interface, and in response to a trigger operation for the one-click/tap uncover control, unblocking, by one click/tap, an equipment parameter blocked by the erasable coating in the associated area; displaying a confirming synthesis control in response to that the equipment parameter blocked by the erasable coating in the associated area is completely uncovered; and displaying a synthesized target virtual equipment and an equipment parameter of the target virtual equipment in response to a trigger operation for the confirming synthesis control.

The erasable coating may be displayed in an associated area of the equipment parameter. For example, the erasable coating may be in an associated area of at least one of the basic attribute parameter and the special effect attribute parameter.

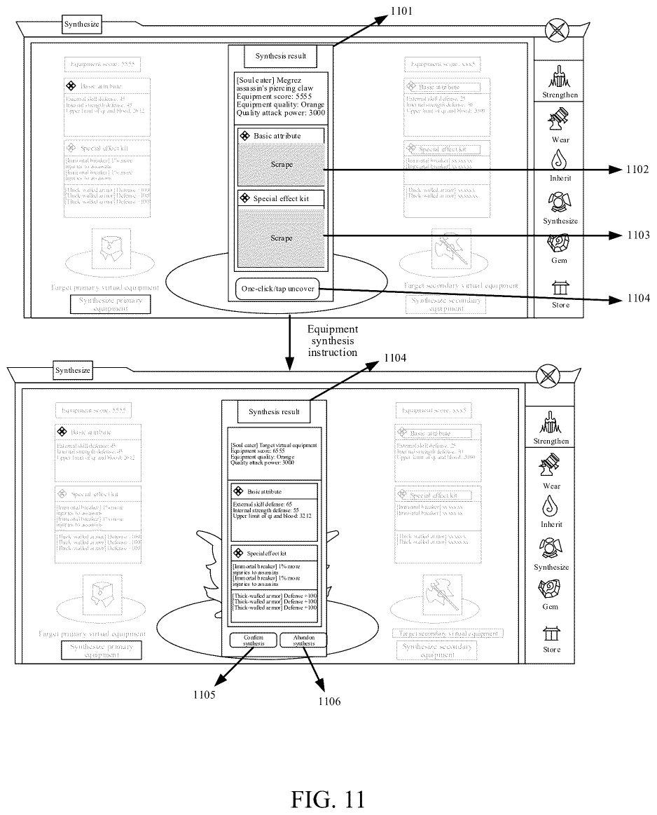

Referring to FIG. 11, FIG. 11 is a schematic diagram of a synthesis result of a virtual equipment according to an embodiment of this application. A terminal displays a synthesis result interface 1101 in response to an equipment synthesis instruction, displays an erasable coating in an associated area 1102 of a basic attribute parameter in the synthesis result interface 1101, displays an erasable layer in an associated area 11003 of a special effect attribute parameter, and displays a one-click/tap uncover control 1104. When a user triggers the erasable coating, the terminal uses the triggered area as a target area in response to the trigger operation for the erasable coating, and eliminates the erasable coating in the target area, to gradually uncover a related equipment parameter blocked by the erasable coating in a corresponding associated area. When the user triggers the one-click/tap uncover control 1104, the terminal immediately removes, in response to the trigger operation for the one-click/tap uncover control 1104, all the erasable coating displayed in the synthesis result interface, and uncovers with one click/tap related equipment parameters (for example, including the basic equipment parameter and the special effect equipment parameter) blocked by the erasable coating in associated areas (including the associated area 1102 and the associated area 1103). When all the equipment parameters blocked by the erasable coating on the synthesis result page 1101 are uncovered, a confirming synthesis control 1105 is displayed in the synthesis result page 1101. When the user triggers the confirming synthesis control 1105, it is considered that the user is satisfied with the current synthesis result. In this case, the target primary virtual equipment and the target secondary virtual equipment are cleared from a virtual equipment warehouse of a current account, a target virtual equipment synthesized according to the target primary virtual equipment and the target secondary virtual equipment is added to the virtual warehouse of the current account, and the synthesized target virtual equipment and an equipment parameter of the target virtual equipment are displayed on the synthesis result page 1101.

In the foregoing manner, the related equipment parameters are blocked by using the erasable coating, thereby improving a feeling of concealment in an equipment synthesis process. The related equipment parameters that are previously blocked are uncovered by eliminating the erasable coating, thereby improving interactivity and interestingness in the equipment synthesis process, and facilitating improving enthusiasm of the user in equipment synthesis.

In some embodiments, the terminal may abandon current equipment synthesis in the following manner: displaying an abandon synthesis control in a process of displaying the confirming synthesis control; and displaying abandonment prompt information in response to a trigger operation for the abandon synthesis control; the synthesis abandonment prompt information being configured for prompting that after synthesizing the target virtual equipment based on the target primary virtual equipment and the target secondary virtual equipment is abandoned, an equipment attribute of the target primary virtual equipment is reserved, and an equipment attribute of the target secondary virtual equipment is decomposed to obtain a virtual resource.

In some embodiments, when the user is not satisfied with the target virtual equipment obtained through the current synthesis, the current equipment synthesis may be canceled by triggering an abandon synthesis control 1106 (for example, abandon synthesis) shown in FIG. 11. In addition, to prevent equipment synthesis from being canceled due to a false touch of the user, secondary confirmation prompt information may further be displayed when the user triggers the abandon synthesis control 1106, to prompt the user that the equipment attribute of the target primary virtual equipment is reserved after the current synthesis is abandoned. However, to reduce losses of the user, the target secondary virtual equipment is decomposed and a corresponding virtual resource is obtained.

In one embodiment, to prevent the user from canceling the current synthesis by forcibly stopping an application process, the terminal may record data of the synthesis result to a cloud while displaying the synthesis result page. If the user forcibly stops the application process, when the user controls the terminal to display the synthesis interface next time, the synthesis result page of the current synthesis is restored to be displayed.

The erasable coating may be displayed in the associated area of the equipment parameter in the synthesis result interface only when the quantity of the special effect attributes of the target virtual equipment is greater than the quantity of the special effect attributes of the target primary virtual equipment and the quantity of the special effect attributes of the target secondary virtual equipment. Accordingly, when presentation diversification of the synthesis result is met, a situation in which an unsatisfactory synthesis result is obtained after the user satisfactorily erases a floating layer can be avoided, thereby improving user experience.

In some embodiments, the target virtual equipment synthesized by the target primary virtual equipment and the target secondary virtual equipment may be displayed in response to the equipment synthesis instruction in the following manner: displaying, in response to an equipment synthesis instruction when equipment quality of the target primary virtual equipment is higher than equipment quality of the target secondary virtual equipment, a target virtual equipment synthesized by using the target primary virtual equipment and the target secondary virtual equipment; the target virtual equipment reserving the equipment quality of the target primary virtual equipment.

The equipment quality refers to quality of the level and the attribute of the virtual equipment, and is usually distinguished by using different colors or labels. Setting of the equipment quality may enable the player to more easily identify and select an appropriate virtual equipment to improve attack power of a role. Using an example in which the virtual scene is a game, common equipment quality categories are as follows: white quality (a virtual equipment having white quality usually represents a common or basic quality virtual equipment, and this type of virtual equipment is referred to as a white equipment for short, has a relatively low attribute bonus, and is applicable to an early stage of a game or a player not having a high requirement on the virtual equipment), blue quality (a virtual equipment having blue quality usually represents an intermediate-level quality equipment, and this type of virtual equipment is referred to as a blue equipment for short, provides a higher attribute bonus than the white equipment, and is suitable for a player to use in the intermediate stage of the game), gold quality (a virtual equipment having gold quality usually represents a high-level quality virtual equipment, and this type of virtual equipment is referred to as a gold equipment for short, an attribute bonus thereof is significantly higher than an attribute bonus of the white equipment and the blue equipment, and may include a special effect or capability, and is applicable to an advanced stage of a game), dark-gold quality (a virtual equipment having dark-gold quality is usually represented as a dark-gold equipment, and this type of virtual equipment is usually one of the rarest quality in a game, and not only has an excellent attribute bonus, but also may have unique skills or a combination effect, which greatly helps improve role strength). In addition to the foregoing basic categories, different games may further have more quality levels, for example, green quality (in some games, a virtual equipment having green quality may represent a virtual equipment having quality slightly better than white quality, or represent a virtual equipment having a special effect in some games), purple quality (an attribute bonus of a virtual equipment having purple quality may be located between attribute bonuses of a blue equipment and a gold equipment, providing a medium attribute bonus and a possible special effect), and orange quality (in some games, a virtual equipment having orange quality may represent an equipment of a legend or myth level, and have extremely high attributes and unique capabilities), and red quality (a virtual equipment having red quality may represent a top-level or sacred-level equipment, and is one of the most powerful equipment in a game). In conclusion, different games may have their own unique equipment quality systems and naming manners, but basic ideas are similar, that is, rarity and practicality of virtual equipment are distinguished by using equipment quality. A player usually needs to obtain a higher-quality virtual equipment by using activities, tasks, copies, or transactions in a game.

In some embodiments, because the maximum quantity of special effect attributes of the synthesized target virtual equipment is limited by the equipment quality of the target virtual equipment (generally, a virtual equipment with higher equipment quality can have more special effect attributes), and the equipment quality of the target virtual equipment finally obtained through synthesis is the same as the equipment quality of the target primary virtual equipment, to avoid a loss of the quantity of the special effect attributes of the synthesized target virtual equipment, the equipment quality of the target primary virtual equipment needs to be higher than the equipment quality of the target secondary virtual equipment. Therefore, in response to the equipment synthesis instruction, the terminal may compare the equipment quality of the target primary virtual equipment with the equipment quality of the target secondary virtual equipment first. When the equipment quality of the target primary virtual equipment is higher than the equipment quality of the target secondary virtual equipment, equipment synthesis is performed based on the target primary virtual equipment and the target secondary virtual equipment, to obtain and display the target virtual equipment obtained through synthesis. Accordingly, the obtained equipment quality of the target virtual equipment reserves the equipment quality of the target primary virtual equipment.

Herein, in one embodiment, when the user selects the target secondary virtual equipment based on the equipment selection instruction triggered by the equipment synthesis control, the equipment quality of the target primary virtual equipment may be compared with the equipment quality of the target secondary virtual equipment, to improve human computer interaction efficiency when the user determines the target secondary virtual equipment.

In some embodiments, the terminal may display the synthesis prompt information in the following manner: displaying synthesis prompt information when the equipment quality of the target primary virtual equipment is lower than the equipment quality of the target secondary virtual equipment; the synthesis prompt information being configured for prompting to inherit the equipment attribute of the target secondary virtual equipment to at least two other secondary virtual equipment, and perform equipment synthesis based on the inherited target secondary virtual equipment and the target primary virtual equipment, or perform equipment synthesis based on the inherited other secondary virtual equipment and the target primary virtual equipment; and equipment quality of the inherited target secondary virtual equipment or equipment quality of the inherited other secondary virtual equipment being lower than the equipment quality of the target primary virtual equipment, and the inherited other secondary virtual equipment matching the target primary virtual equipment.

The inheritance of the equipment quality usually refers to a process of transferring or inheriting quality of one virtual equipment to another virtual equipment in a game. This manner allows players to optimize their equipment combinations without completely collecting or building a new equipment from the beginning. For example, a player may transfer some or all attributes (such as attack power, defense power, and endurance) of one high-quality virtual equipment (source equipment) to another virtual equipment (target equipment), so that attributes of the target equipment are improved. Alternatively, the player may inherit a special effect (for example, adding magic damage or providing a special skill) of one high-quality virtual equipment (source equipment) to another virtual equipment (target equipment). Alternatively, a player may inherit a level or an empirical value of one high-quality virtual equipment (source equipment) to another virtual equipment (target equipment), so that after inheriting the level, the target equipment has the same level or empirical value as the source virtual equipment.

The inheritance manners of the equipment quality include, but are not limited to, the following several manners: combining two or more virtual equipment by using a synthesis or merging operation, so that a target equipment obtained by means of combination obtains quality or an attribute of a source equipment; permanently endowing the target equipment with a feature of the source equipment by means of a special engraving or imprinting process; and directly transferring the attribute of the source equipment to the target equipment by using a specific prop or function provided in a game. For example, a player may transfer the quality, appended attributes, and gem sockets of a source equipment to a target equipment through an equipment inheritance system, but these attributes of the source equipment will disappear after the transfer; as another example, a player may transfer effects of late-stage enhancements such as strengthening, amplification, and forging from the source equipment to another target equipment in the same equipment slot; as yet another example, a player may transfer refinement and infusion attributes from the source equipment to the target equipment.

The equipment quality inheritance usually has specific conditions and limitations. For example, the source equipment and the target equipment need to be of the same type or the same slot, or need to consume particular resources (such as gold coins, materials, or special props). In addition, inheritance may reduce the quality or the attribute of the source equipment, or affect an existing attribute of the target equipment.

In some embodiments, when the equipment quality of the target secondary virtual equipment is higher than the equipment quality of the target primary virtual equipment, the terminal displays synthesis prompt information on the synthesis interface, to prompt the user that if equipment synthesis continues to be performed based on the target secondary virtual equipment and the target primary virtual equipment, the equipment quality of the target secondary virtual equipment is caused to be lost, and to prompt to inherit (that is, transfer) the equipment attribute of the target secondary virtual equipment to at least two other secondary virtual equipment, and perform equipment synthesis based on the inherited target secondary virtual equipment and target primary virtual equipment, or perform equipment synthesis based on inherited other secondary virtual equipment and the target primary virtual equipment.

Using an example in which a quantity of equipment attributes corresponding to the equipment quality of the target secondary virtual equipment is 8, and a maximum quantity of equipment attributes corresponding to the equipment quality of the target primary virtual equipment is 4, because the equipment quality of the target secondary virtual equipment is higher than the equipment quality of the target primary virtual equipment, to avoid a loss in the equipment quality of the target secondary virtual equipment caused by directly performing equipment synthesis based on the target primary virtual equipment and the target secondary virtual equipment, all equipment attributes of the target secondary virtual equipment may be inherited to at least two other secondary virtual equipment (still matching the target primary virtual equipment). It is assumed that three equipment attributes of the target secondary virtual equipment are inherited to another secondary virtual equipment A, three equipment attributes of the target secondary virtual equipment are inherited to another secondary virtual equipment B, and two equipment attributes of the target secondary virtual equipment are inherited to another secondary virtual equipment C. Accordingly, the equipment attribute of the another secondary virtual equipment A after being inherited is 5 (before being inherited, the another secondary virtual equipment A has two equipment attributes), the equipment attribute of the another secondary virtual equipment B after being inherited is 4 (it is assumed that before being inherited, the another secondary virtual equipment B has one equipment attribute), the equipment attribute of the another secondary virtual equipment A after being inherited is 5 (it is assumed that before being inherited, the another secondary virtual equipment A has two equipment attributes), and the equipment attribute of the another secondary virtual equipment C after being inherited is 3 (it is assumed that before being inherited, the another secondary virtual equipment C has one equipment attribute). Because the quantity of the equipment attributes of the another secondary virtual equipment C after being inherited is less than the maximum quantity of equipment attributes corresponding to the equipment quality of the target primary virtual equipment, the user may be prompted to perform equipment synthesis based on the inherited another secondary virtual equipment C and the target primary virtual equipment.

In addition, when the equipment quality of the target secondary virtual equipment is higher than the equipment quality of the target primary virtual equipment, to avoid a loss of the equipment quality of the target secondary virtual equipment caused by directly performing equipment synthesis based on the target primary virtual equipment and the target secondary virtual equipment, the equipment attributes of the target secondary virtual equipment may further be partially inherited to another secondary virtual equipment, and the inheritance is stopped when a quantity of the equipment attributes of the target secondary virtual equipment after the inheritance is less than a maximum quantity of equipment attributes corresponding to the equipment quality of the target primary virtual equipment (that is, the equipment quality of the target secondary virtual equipment after the inheritance is less than the equipment quality of the target primary virtual equipment). Continue the foregoing example. Three equipment attributes of the target secondary virtual equipment may be inherited to the another secondary virtual equipment A, and two equipment attributes of the target secondary virtual equipment are inherited to another secondary virtual equipment B. Accordingly, there are three remaining equipment attributes of the target secondary virtual equipment, which are less than the maximum quantity of equipment attributes corresponding to the equipment quality of the target primary virtual equipment. That is, the equipment quality of the inherited target secondary virtual equipment is less than the equipment quality of the target primary virtual equipment. Therefore, it may be prompted to perform equipment synthesis based on the inherited target secondary virtual equipment and the target primary virtual equipment.

In the foregoing manner, during equipment synthesis, the equipment quality of the target primary virtual equipment and the target secondary virtual equipment are fully considered. When the equipment quality of the target secondary virtual equipment is higher than the equipment quality of the target primary virtual equipment, the equipment quality of the target secondary virtual equipment is inherited or transferred, and equipment synthesis is performed based on the inherited or transferred secondary virtual equipment. This not only achieves an objective of synthesizing a target virtual equipment of specific equipment quality, but also avoids a loss of the equipment quality, and ensures practical and good benefits of players.

In some embodiments, the target virtual equipment synthesized by the target primary virtual equipment and the target secondary virtual equipment may be displayed in response to the equipment synthesis instruction in the following manner: presenting an equipment synthesis special effect in response to an equipment synthesis instruction; and stopping presenting the equipment synthesis special effect in response to that a special effect presentation stop condition is satisfied, and displaying the target virtual equipment synthesized by the target primary virtual equipment and the target secondary virtual equipment, the special effect presentation stop condition including at least one of the following: presentation duration of the equipment synthesis special effect reaches target duration, a quantity of presentation times of the equipment synthesis special effect reaches a target quantity of times, and an operation for closing the equipment synthesis special effect is received.

In some embodiments, in response to the equipment synthesis instruction, the terminal may first present an equipment synthesis special effect (for example, an equipment synthesis animation, or an equipment synthesis painted eggshell), stop presenting the equipment synthesis special effect when a special effect presentation stop condition is satisfied, and then display the synthesized target virtual equipment. Accordingly, not only interestingness and attractiveness of equipment synthesis can be improved, but also utilization of a screen of the terminal can be improved.

The special effect presentation stop condition is configured for indicating a presentation stop moment of the equipment synthesis special effect. In some embodiments, the special effect presentation stop condition may be set according to specific requirements. For example, the special effect presentation stop condition may be set to be related to presentation duration or a quantity of presentation times of the equipment synthesis special effect. For example, the presentation duration of the equipment synthesis special effect reaches target duration (which may be set according to specific requirements, for example, set to 5 seconds), or the presentation duration of the equipment synthesis special effect reaches a target quantity of times (which may be set according to specific requirements, for example, set to 2 times). It may be determined that the presentation stop moment of the equipment synthesis special effect arrives, that is, the special effect presentation stop condition is satisfied. For another example, the special effect presentation stop condition is set to be related to a trigger operation of a user. For example, when the user triggers a close operation (for example, triggered by triggering a skip control or a close control associated with the equipment synthesis special effect) for the equipment synthesis special effect, it may be determined that a presentation stop moment of the equipment synthesis special effect arrives, that is, the special effect presentation stop condition is satisfied. For another example, synthesis result uncover prompt information is displayed. When a confirm operation is performed on the synthesis result uncover prompt information, it may be determined that a presentation stop moment of the equipment synthesis special effect arrives, that is, the special effect presentation stop condition is satisfied.

In the foregoing manner, an equipment selection control is displayed in a synthesis interface of a virtual equipment. If a user triggers the equipment selection control to transmit an equipment selection instruction, a target primary virtual equipment instructed by the equipment selection instruction to be selected and a target secondary virtual equipment matching the target primary virtual equipment are displayed in the synthesis interface. In this case, if an equipment synthesis instruction transmitted by the user is received, a target virtual equipment synthesized by the target primary virtual equipment and the target secondary virtual equipment is displayed in the synthesis interface. The synthesized target virtual equipment is obtained through random synthesis based on equipment attributes of the target primary virtual equipment and the target secondary virtual equipment. Accordingly, randomness of virtual equipment synthesis can be improved, and a possibility that an equipment attribute of the synthesized target virtual equipment reaches an upper limit can be increased to some extent. This enables players pursuing extreme equipment to always have continuous goal pursuits, which is beneficial to expanding equipment depth and increasing synthesis utilization of the virtual equipment.

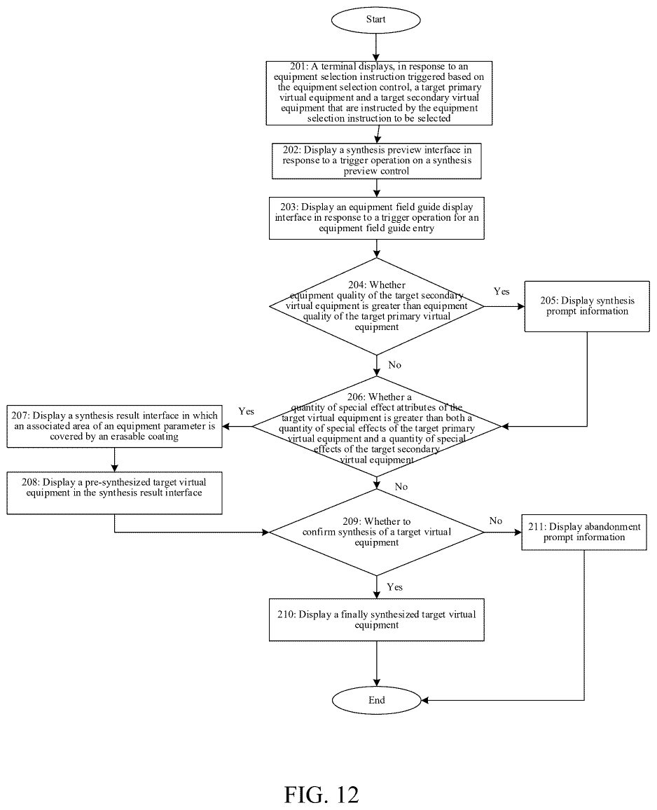

The following describes an application of the embodiments of this application in a use scenario. An example in which a virtual scene is a game and a virtual equipment is an equipment in the game is used, and the synthesis method for a virtual equipment provided in the embodiments of this application continues to be described. Referring to FIG. 12, FIG. 12 is a schematic flowchart of a synthesis method for a virtual equipment according to an embodiment of this application. The method includes the following operations.

Operation 201: A terminal displays, in response to an equipment selection instruction triggered based on the equipment selection control, a target primary virtual equipment and a target secondary virtual equipment that are instructed by the equipment selection instruction to be selected.

In one embodiment, the terminal displays a primary equipment selection control and a secondary equipment selection control in a synthesis interface of a virtual equipment, displays a primary equipment selection interface in response to a trigger operation for the primary equipment selection control, and displays at least one candidate primary virtual equipment such as a candidate primary virtual equipment 1, a candidate primary virtual equipment 2, and a candidate primary virtual equipment 3 in the primary equipment selection interface; and in response to a selection operation for the candidate primary virtual equipment (for example, the candidate primary virtual equipment 2), displays an equipment information interface of the candidate primary virtual equipment, so that a user views equipment information of the candidate primary virtual equipment to determine whether to select the candidate primary virtual equipment for synthesis. The user may determine the currently selected candidate primary virtual equipment as the target primary virtual equipment by triggering an equipment determining control, cancel displaying of the primary equipment selection interface, and display the target primary virtual equipment in the synthesis interface. In this case, when the user triggers the secondary equipment selection control, the terminal displays a secondary equipment selection interface, and displays at least one candidate secondary virtual equipment such as a candidate secondary virtual equipment 1 and a candidate secondary virtual equipment 2 in the secondary equipment selection interface; and in response to a selection operation for the candidate secondary virtual equipment (for example, the candidate secondary virtual equipment 2), the terminal displays an equipment information interface of the candidate secondary virtual equipment, so that the user views equipment information of the candidate secondary virtual equipment to determine whether to select the candidate secondary virtual equipment for synthesis. In this case, the user may determine the currently selected candidate secondary virtual equipment as the target secondary virtual equipment by triggering the equipment determining control, cancel display of the secondary equipment selection interface, and display the target primary virtual equipment and the target secondary virtual equipment in the synthesis interface.

Herein, when at least one candidate secondary virtual equipment is displayed in the secondary equipment selection interface, the displayed candidate secondary virtual equipment is a virtual equipment whose wearing location is the same as that of the target primary virtual equipment and that is not worn by a virtual role.

Operation 202: Display a synthesis preview interface in response to a trigger operation on a synthesis preview control.

In one embodiment, after the user determines a to-be-synthesized target primary virtual equipment and target secondary virtual equipment, the terminal displays the synthesis preview control in the synthesis interface. In response to a trigger operation on the preview control, the terminal displays a synthesis preview interface in the synthesis interface. The synthesis preview interface is configured for displaying equipment quality, a basic attribute range, and a special effect attribute range of a preview virtual equipment synthesized based on the target primary virtual equipment and the target secondary virtual equipment, for the user to reference to determine whether to continue to perform equipment synthesis by using the target primary virtual equipment and the target secondary virtual equipment to be synthesized currently. The equipment quality of the preview virtual equipment is the same as the equipment quality of the target primary virtual equipment, and the basic attribute range of the preview virtual equipment is obtained by using the basic attributes of the target primary virtual equipment and the target secondary virtual equipment. The special effect attribute range of the preview virtual equipment includes all special effect attributes of the target primary virtual equipment and the target secondary virtual equipment.

Operation 203: Display an equipment field guide display interface in response to a trigger operation for an equipment field guide entry.

In one embodiment, the terminal displays an equipment field guide entry in the synthesis preview interface. In response to a trigger operation for the equipment field guide entry, the terminal displays an equipment field guide display interface beside the synthesis preview interface. Herein, the equipment field guide display interface is configured for displaying an equipment field guide of the preview virtual equipment. The user may learn limit equipment quality, a limit basic attribute, and a limit special effect attribute of the preview virtual equipment by viewing the equipment field guide corresponding to the preview virtual equipment.

Operation 204: Determine, in response to an equipment synthesis instruction triggered based on an equipment synthesis control, whether equipment quality of the target secondary virtual equipment is greater than equipment quality of the target primary virtual equipment.

Herein, when the equipment quality of the target secondary virtual equipment is greater than the equipment quality of the target primary virtual equipment, operation 205 is performed; otherwise, operation 206 is performed.

Operation 205: Display synthesis prompt information.

In some embodiments, because a maximum quantity of special effect attributes of a virtual equipment is limited by equipment quality of the virtual equipment (that is, a virtual equipment with higher equipment quality can have more special effect attributes), and equipment quality of a target virtual equipment obtained through final synthesis is the same as the equipment quality of the target primary virtual equipment. To avoid a loss of a quantity of special effect attributes of the synthesized target virtual equipment, during equipment synthesis, the equipment quality of the target primary virtual equipment needs to be higher than the equipment quality of the target secondary virtual equipment. Therefore, when the equipment quality of the target secondary virtual equipment is higher than the equipment quality of the target primary virtual equipment, operation 205 is entered. The terminal displays, in the synthesis interface, a prompt for inheriting the equipment attribute of the target secondary virtual equipment to at least two other secondary virtual equipment, and performs equipment synthesis based on the inherited target secondary virtual equipment and target primary virtual equipment, or performs equipment synthesis based on the inherited other secondary virtual equipment and target primary virtual equipment.

Operation 206: Determine whether a quantity of special effect attributes of the target virtual equipment is greater than both a quantity of special effects of the target primary virtual equipment and a quantity of special effects of the target secondary virtual equipment.

Herein, when the quantity of special effect attributes of the target virtual equipment is greater than the quantity of special effects of the target primary virtual equipment and the quantity of special effect attributes of the target virtual equipment is greater than the quantity of special effects of the target secondary virtual equipment, operation 207 is performed; otherwise, operation 209 is performed.

Operation 207: Display a synthesis result interface in which an associated area of an equipment parameter is covered by an erasable coating.

In some embodiments, when the quantity of the special effect attributes of the target virtual equipment is greater than the quantity of the special effects of the target primary virtual equipment and the quantity of the special effects of the target secondary virtual equipment, to make presentation of the synthesis result more intense and stimulative, in response to a trigger operation performed by the user on an erasable layer at a target location, display of the erasable layer at the target location is canceled, to gradually uncover the equipment parameter covered by the erasable layer in the associated area.

When the quantity of special effect attributes of the target virtual equipment is less than at least one of the quantity of special effects of the target primary virtual equipment and the quantity of the special effects of the target secondary virtual equipment in operation 206, or after the erasable coating is completely eliminated in operation 207, operation 208 is performed.

Operation 208: Display a pre-synthesized target virtual equipment in the synthesis result interface.

In one embodiment, the terminal displays the target virtual equipment pre-synthesized by the target primary virtual equipment and the target secondary virtual equipment and the equipment parameter of the target virtual equipment in the complete synthesis result interface, and displays a confirming synthesis control and an abandon synthesis control. The equipment quality of the target equipment is the same as the equipment quality of the target primary virtual equipment. A basic attribute parameter of the target equipment is randomly obtained from an interval with the basic attribute of the target primary virtual equipment and the basic attribute of the target secondary virtual equipment as endpoints, and the special attribute of the target equipment.

Operation 209: Determine whether to confirming synthesis of a target virtual equipment.

Herein, when the user determines to synthesize the target virtual equipment (for example, the user triggers the confirming synthesis control), operation 210 may be performed. Otherwise, when the user cancels synthesizing the target virtual equipment (for example, triggers the abandon synthesis control), operation 211 is performed.

Operation 210: Display a finally synthesized target virtual equipment.

In one embodiment, when the user triggers the confirming synthesis control, it is considered that the user is satisfied with the current synthesis result. In this case, the target primary virtual equipment and the target secondary virtual equipment are cleared from a virtual equipment warehouse of a current account, and the target virtual equipment is added to the virtual warehouse of the current account, and the finally synthesized target virtual equipment and an equipment parameter of the target virtual equipment are displayed on a synthesis result page.

Operation 211: Display abandonment prompt information.

In one embodiment, the user may be unsatisfied with the synthesized virtual equipment. Therefore, the abandon synthesis control that may be configured for canceling the current synthesis is provided for the user. To prevent equipment synthesis from being canceled due to a false touch of the user, when the user triggers the abandon synthesis control, secondary confirmation prompt information may be displayed, to prompt the user that the current synthesis is to be abandoned and the target secondary virtual equipment is to be decomposed and a corresponding virtual resource is obtained. Accordingly, a synthesis mis-operation is avoided by using a further prompt, thereby reducing operation costs of the player.

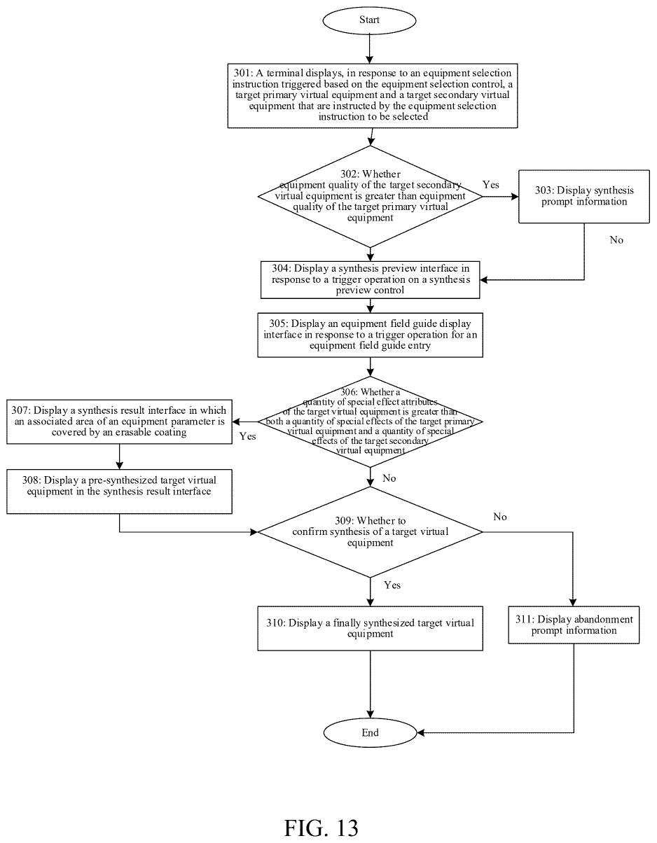

The following continues to describe the synthesis method for a virtual equipment provided in an embodiment of this application. Referring to FIG. 13, FIG. 13 is a schematic flowchart of a synthesis method for a virtual equipment according to an embodiment of this application. The method includes the following operations.

Operation 301: A terminal displays, in response to an equipment selection instruction triggered based on the equipment selection control, a target primary virtual equipment and a target secondary virtual equipment that are instructed by the equipment selection instruction to be selected.

In some embodiments, when there is only one equipment selection control displayed in the synthesis interface of the virtual equipment, the terminal displays an equipment selection interface in response to a trigger operation for the equipment selection control, and displays a primary equipment selection area and a secondary equipment selection area in the equipment selection interface. The primary equipment selection area displays at least one candidate primary virtual equipment. When the user selects a target primary virtual equipment therefrom, the terminal displays the selected target primary virtual equipment in response to the selection operation, and further triggers a corresponding equipment selection instruction in the secondary equipment selection area based on the selected target primary virtual equipment, to display, in the secondary equipment selection area, the target secondary virtual equipment instructed by the equipment selection instruction to be selected.

Herein, when at least one candidate secondary virtual equipment is displayed in the secondary equipment selection interface, the displayed candidate secondary virtual equipment is a virtual equipment whose wearing location is the same as that of the target primary virtual equipment and that is not worn by a virtual role.

Operation 302: Determine whether equipment quality of the target secondary virtual equipment is greater than equipment quality of the target primary virtual equipment.

In one embodiment, after displaying the target primary virtual equipment and the target secondary virtual equipment in the synthesis interface, the terminal automatically determines whether the equipment quality of the target secondary virtual equipment is greater than the equipment quality of the target primary virtual equipment. Alternatively, after the user determines the target primary virtual equipment and selects the target secondary virtual equipment based on the equipment selection instruction triggered by the equipment selection control, the terminal may compare the equipment quality of the target primary virtual equipment with the equipment quality of the target secondary virtual equipment, to improve pertinence when the user determines the target secondary virtual equipment.

Herein, when the equipment quality of the target secondary virtual equipment is greater than the equipment quality of the target primary virtual equipment, operation 303 is performed; otherwise, operation 304 is performed.

Operation 303: Display synthesis prompt information.

In some embodiments, because a maximum quantity of special effect attributes of a virtual equipment is limited by equipment quality of the virtual equipment (that is, a virtual equipment with higher equipment quality can have more special effect attributes), and equipment quality of a target virtual equipment obtained through final synthesis is the same as the equipment quality of the target primary virtual equipment. To avoid a loss of a quantity of special effect attributes of the synthesized target virtual equipment, during equipment synthesis, the equipment quality of the target primary virtual equipment needs to be higher than the equipment quality of the target secondary virtual equipment. Therefore, when the equipment quality of the target secondary virtual equipment is higher than the equipment quality of the target primary virtual equipment, operation 303 is entered. The terminal displays, in the synthesis interface, the terminal for prompting the user that if continuing to perform equipment synthesis based on the target secondary virtual equipment and the target primary virtual equipment, the equipment quality of the target secondary virtual equipment is caused to be lost, and may prompt the user to reselect the target secondary virtual equipment, or prompt to inherit an equipment attribute of the selected target secondary virtual equipment to at least two other secondary virtual equipment, and perform equipment synthesis based on the inherited target secondary virtual equipment and target primary virtual equipment, or perform equipment synthesis based on the inherited other secondary virtual equipment and target primary virtual equipment.

Operation 304: Display a synthesis preview interface in response to a trigger operation on a synthesis preview control.

In one embodiment, after the user determines a to-be-synthesized target primary virtual equipment and target secondary virtual equipment, the terminal displays the synthesis preview control in the synthesis interface. In response to a trigger operation on the preview control, the terminal displays a synthesis preview interface in the synthesis interface. The synthesis preview interface is configured for displaying equipment quality, a basic attribute range, and a special effect attribute range of a preview virtual equipment synthesized based on the target primary virtual equipment and the target secondary virtual equipment, for the user to reference to determine whether to continue to perform equipment synthesis by using the target primary virtual equipment and the target secondary virtual equipment to be synthesized currently. The equipment quality of the preview virtual equipment is the same as the equipment quality of the target primary virtual equipment, and the basic attribute range of the preview virtual equipment is obtained by using the basic attributes of the target primary virtual equipment and the target secondary virtual equipment. The special effect attribute range of the preview virtual equipment includes all special effect attributes of the target primary virtual equipment and the target secondary virtual equipment.

Operation 305: Display an equipment field guide display interface in response to a trigger operation for an equipment field guide entry.

In one embodiment, the terminal displays an equipment field guide entry in the synthesis preview interface. In response to a trigger operation for the equipment field guide entry, the terminal displays an equipment field guide display interface beside the synthesis preview interface. Herein, the equipment field guide display interface is configured for displaying an equipment field guide of the preview virtual equipment. The user may learn limit equipment quality, a limit basic attribute, and a limit special effect attribute of the preview virtual equipment by viewing the equipment field guide corresponding to the preview virtual equipment.

Operation 306: Determine, in response to an equipment synthesis instruction triggered based on an equipment synthesis control, whether a quantity of special effect attributes of the target virtual equipment is greater than both a quantity of special effects of the target primary virtual equipment and a quantity of special effects of the target secondary virtual equipment.

Herein, when the quantity of special effect attributes of the target virtual equipment is greater than the quantity of special effects of the target primary virtual equipment and the quantity of special effect attributes of the target virtual equipment is greater than the quantity of special effects of the target secondary virtual equipment, operation 307 is performed; otherwise, operation 309 is performed.

Operation 307: Display a synthesis result interface in which an associated area of an equipment parameter is covered by an erasable coating.

In some embodiments, when the quantity of the special effect attributes of the target virtual equipment is greater than the quantity of the special effects of the target primary virtual equipment and the quantity of the special effects of the target secondary virtual equipment, to make presentation of the synthesis result more intense and stimulative, in response to a trigger operation performed by the user on an erasable layer at a target location, display of the erasable layer at the target location is canceled, to gradually uncover the equipment parameter covered by the erasable layer in the associated area.

When the quantity of special effect attributes of the target virtual equipment is less than at least one of the quantity of special effects of the target primary virtual equipment and the quantity of the special effects of the target secondary virtual equipment in operation 306, or after the erasable coating is completely eliminated in operation 307, operation 308 is performed.

Operation 308: Display a pre-synthesized target virtual equipment in the synthesis result interface.

In one embodiment, the terminal displays the target virtual equipment synthesized by the target primary virtual equipment and the target secondary virtual equipment and the equipment parameter of the target virtual equipment in the complete synthesis result interface, and displays a confirming synthesis control and an abandon synthesis control. The equipment quality of the target equipment is the same as the equipment quality of the target primary virtual equipment. A basic attribute parameter of the target equipment is randomly obtained from an interval with the basic attribute of the target primary virtual equipment and the basic attribute of the target secondary virtual equipment as endpoints, and the special attribute of the target equipment.

Operation 309: Determine whether to confirming synthesis of a target virtual equipment.

Herein, when the user determines to synthesize the target virtual equipment (for example, the user triggers the confirming synthesis control), operation 310 may be performed. Otherwise, when the user cancels synthesizing the target virtual equipment (for example, triggers the abandon synthesis control), operation 311 is performed.

Operation 310: Display a finally synthesized target virtual equipment.

In one embodiment, when the user triggers the confirming synthesis control, it is considered that the user is satisfied with the current synthesis result. In this case, the target primary virtual equipment and the target secondary virtual equipment are cleared from a virtual equipment warehouse of a current account, and the target virtual equipment is added to the virtual warehouse of the current account, and the finally synthesized target virtual equipment and an equipment parameter of the target virtual equipment are displayed on a synthesis result page.

Operation 311: Display abandonment prompt information.

In one embodiment, the user may be unsatisfied with the synthesized virtual equipment. Therefore, the abandon synthesis control that may be configured for canceling the current synthesis is provided for the user. To prevent equipment synthesis from being canceled due to a false touch of the user, when the user triggers the abandon synthesis control, secondary confirmation prompt information may be displayed, to prompt the user that the current synthesis is to be abandoned and the target secondary virtual equipment is to be decomposed and a corresponding virtual resource is obtained. Accordingly, a synthesis mis-operation is avoided by using a further prompt, thereby reducing operation costs of the player.

By means of the design of the foregoing equipment synthesis function, the corresponding target virtual equipment may be synthesized by using a random combination of the target primary virtual equipment and the target secondary virtual equipment. The synthesized target virtual equipment is obtained through random synthesis based on equipment attributes of the target primary virtual equipment and the target secondary virtual equipment. Accordingly, randomness of virtual equipment synthesis can be improved, and a pursuit upper limit of the virtual equipment is greatly improved to some extent. Players pursuing extreme equipment are always continuously synthesizing and pursuing equipment. The synthesis depth of the equipment is greatly expanded, thereby improving player experience. In addition, implementation costs of the equipment synthesis function provided in this embodiment of this application are relatively low, which is an extremely cost-efficient solution.

So far, with reference to the application and implementation of the electronic device provided in the embodiments of this application, the synthesis method for a virtual equipment provided in the embodiments of this application is described. The following continues to describe implementation of a synthesis solution of the virtual equipment through cooperation between modules in a synthesis apparatus 555 for a virtual equipment provided in the embodiments of this application.

A first display module 5551 is configured to display an equipment selection control in a synthesis interface of a virtual equipment; a second display module 5552 is configured to: display, in response to an equipment selection instruction triggered based on the equipment selection control, a target primary virtual equipment and a target secondary virtual equipment that are instructed by the equipment selection instruction to be selected, the target secondary virtual equipment matching the target primary virtual equipment; and a third display module 5553 is configured to display a synthesized target virtual equipment in response to an equipment synthesis instruction, the target virtual equipment being obtained by random synthesis based on equipment attributes of the target primary virtual equipment and the target secondary virtual equipment.

In some embodiments, the equipment selection control includes a primary equipment selection control and a secondary equipment selection control, and the second display module is further configured to: display a primary equipment selection interface in response to a trigger operation for the primary equipment selection control, and display at least one candidate primary virtual equipment in the primary equipment selection interface; display, in response to an equipment selection instruction for a target primary virtual equipment of the at least one candidate primary virtual equipment, the target primary virtual equipment; display a secondary equipment selection interface in response to a trigger operation for the secondary equipment selection control, and display at least one candidate secondary virtual equipment in the secondary equipment selection interface, the candidate secondary virtual equipment matching the target primary virtual equipment; and display, in response to an equipment selection instruction for a target secondary virtual equipment of the at least one candidate secondary virtual equipment, the target secondary virtual equipment.

In some embodiments, the second display module is further configured to: when there are at least two candidate secondary virtual equipment, obtain an influencing parameter configured for influencing a selection priority of each candidate secondary virtual equipment, the influencing parameter including at least one of the following: an adaptation degree between the candidate secondary virtual equipment and the target primary virtual equipment, an equipment attribute feature of the candidate secondary virtual equipment, and a historical selection rate corresponding to the candidate secondary virtual equipment; invoke a neural network model to perform priority prediction based on the influencing parameter, to obtain the selection priority of each candidate secondary virtual equipment; and display each candidate secondary virtual equipment in the secondary equipment selection interface in a display style corresponding to each selection priority.

In some embodiments, the apparatus further includes: an equipment update module, configured to display an equipment update entry in a primary equipment selection interface or a secondary equipment selection interface, where the equipment update entry is configured for updating at least one candidate primary virtual equipment in the primary equipment selection interface, or configured for updating at least one candidate secondary virtual equipment in the secondary equipment selection interface.

In some embodiments, the second display module is further configured to: display an equipment selection interface in response to a trigger operation for the equipment selection control, the equipment selection interface including a primary equipment selection area and a secondary equipment selection area, and the primary equipment selection area including at least one candidate primary virtual equipment; display, in response to an equipment selection instruction for a target primary virtual equipment of at least one candidate primary virtual equipment, the target primary virtual equipment; and display, based on the target primary virtual equipment in response to an equipment selection instruction triggered in the secondary equipment selection area, a target secondary virtual equipment instructed by the equipment selection instruction to be selected.

In some embodiments, the second display module is further configured to: display at least one candidate secondary virtual equipment in the secondary equipment selection area, the candidate secondary virtual equipment matching the target primary virtual equipment; and display, in response to an equipment selection instruction for a target secondary virtual equipment of the at least one candidate secondary virtual equipment, the target secondary virtual equipment.

In some embodiments, before displaying the target primary virtual equipment, the second display module is further configured to: display at least two candidate secondary virtual equipment in the secondary equipment selection area in a first display style. Correspondingly, after displaying the target primary virtual equipment, the second display module is further configured to: display a first part of candidate secondary virtual equipment in the at least two candidate secondary virtual equipment in a second display style, and display a second part of candidate secondary virtual equipment in the at least two candidate secondary virtual equipment in a third display style, where the second display style is configured for indicating that the first part of candidate secondary virtual equipment matches the target primary virtual equipment, and the third display style is configured for indicating that the second part of candidate secondary virtual equipment does not match the target primary virtual equipment; and in response to an equipment selection instruction for a target secondary virtual equipment in the first part of candidate secondary virtual equipment, display the target secondary virtual equipment.

In some embodiments, the apparatus further includes a first prompt module, configured to display selection prompt information in response to a selection operation for the candidate secondary virtual equipment in the second part of candidate secondary virtual equipment, where the selection prompt information is configured for prompting to reject selection of a candidate secondary virtual equipment not matching the target primary virtual equipment, or configured for prompting to reselect a candidate secondary virtual equipment matching the target primary virtual equipment.

In some embodiments, before displaying, in response to the equipment synthesis instruction, the target virtual equipment synthesized by the target primary virtual equipment and the target secondary virtual equipment, the apparatus further includes a synthesis preview module, configured to: display a synthesis preview control; and display a synthesis preview interface in response to a trigger operation for the synthesis preview control, and display, in the synthesis preview interface, an equipment attribute range of a preview virtual equipment synthesized based on the target primary virtual equipment and the target secondary virtual equipment; the equipment attribute range including at least one of the following: a basic attribute range and a special effect attribute range, configured for reference to determine whether to trigger the equipment synthesis instruction.

In some embodiments, the synthesis preview module is further configured to: display, in a synthesis preview interface, an equipment field guide entry for the preview virtual equipment, display an equipment field guide display interface in response to a trigger operation for the equipment field guide entry, and display, in the equipment field guide display interface, an equipment field guide of the preview virtual equipment.

In some embodiments, the third display module is further configured to: display an equipment synthesis control; and display a synthesis result interface in response to an equipment synthesis instruction triggered based on the equipment synthesis control, and display a target virtual equipment and an equipment parameter of the target virtual equipment in the synthesis result interface; the equipment parameter of the target virtual equipment including a basic attribute parameter and a special effect attribute parameter, and being obtained by random synthesis of an equipment parameter of the target primary virtual equipment and an equipment parameter of the target secondary virtual equipment.

In some embodiments, the third display module is further configured to: display an erasable coating in an associated area of the equipment parameter in the synthesis result interface, and gradually uncover, in response to an erase operation for the erasable coating, an equipment parameter blocked by the erasable coating in the associated area; or display a one-click/tap uncover control in the synthesis result interface, and in response to a trigger operation for the one-click/tap uncover control, unblock, by one click/tap, an equipment parameter blocked by the erasable coating in the associated area; display a confirming synthesis control in response to that the equipment parameter blocked by the erasable coating in the associated area is completely uncovered; and display a synthesized target virtual equipment and an equipment parameter of the target virtual equipment in response to a trigger operation for the confirming synthesis control.

In some embodiments, the apparatus further includes a second prompt module, configured to: display an abandon synthesis control in a process of displaying the confirming synthesis control; and display abandonment prompt information in response to a trigger operation for the abandon synthesis control; the synthesis abandonment prompt information being configured for prompting that after synthesizing the target virtual equipment based on the target primary virtual equipment and the target secondary virtual equipment is abandoned, an equipment attribute of the target primary virtual equipment is reserved, and an equipment attribute of the target secondary virtual equipment is decomposed to obtain a virtual resource.

In some embodiments, the third display module is further configured to: display, in response to an equipment synthesis instruction when equipment quality of the target primary virtual equipment is higher than equipment quality of the target secondary virtual equipment, a target virtual equipment synthesized by using the target primary virtual equipment and the target secondary virtual equipment; the target virtual equipment reserving the equipment quality of the target primary virtual equipment.

In some embodiments, the apparatus further includes a third prompt module, configured to: display synthesis prompt information when the equipment quality of the target primary virtual equipment is lower than the equipment quality of the target secondary virtual equipment; the synthesis prompt information being configured for prompting to inherit the equipment attribute of the target secondary virtual equipment to at least two other secondary virtual equipment, and perform equipment synthesis based on the inherited target secondary virtual equipment and the target primary virtual equipment, or perform equipment synthesis based on the inherited other secondary virtual equipment and the target primary virtual equipment; and equipment quality of the inherited target secondary virtual equipment or equipment quality of the inherited other secondary virtual equipment being lower than the equipment quality of the target primary virtual equipment, and the inherited other secondary virtual equipment matching the target primary virtual equipment.

In some embodiments, the third display module is further configured to: present an equipment synthesis special effect in response to an equipment synthesis instruction; and stop presenting the equipment synthesis special effect in response to that a special effect presentation stop condition is satisfied, and display the target virtual equipment synthesized by the target primary virtual equipment and the target secondary virtual equipment, the special effect presentation stop condition including at least one of the following: presentation duration of the equipment synthesis special effect reaches target duration, a quantity of presentation times of the equipment synthesis special effect reaches a target quantity of times, and an operation for closing the equipment synthesis special effect is received.

An embodiment of this application provides a computer program product, where the computer program product includes a computer program or computer-executable instructions, and the computer program or the computer-executable instructions are stored in a computer-readable storage medium. A processor of an electronic device reads the computer-executable instructions from the computer-readable storage medium, and the processor executes the computer-executable instructions, to cause the electronic device to perform the synthesis method for a virtual equipment according to the embodiments of this application.

The embodiments of this application provide a computer-readable storage medium, having computer-executable instructions or a computer program stored therein. When the computer-executable instructions or the computer program is executed by a processor, the processor is enabled to perform the synthesis method for a virtual equipment provided in the embodiments of this application, for example, the synthesis method for a virtual equipment shown in FIG. 3.

In some embodiments, the computer-readable storage medium may be a memory such as an FRAM, a ROM, a PROM, an EPROM, an EEPROM, a flash memory, a magnetic surface memory, an optical disk, or a CD-ROM, or may be any device including one of or any combination of the foregoing memories.

In some embodiments, the computer-executable instructions may be compiled in a form of a program, software, a software module, a script, or code, in any form of a programming language (including a compilation or interpretation language, or a declarative or procedural language), and may be deployed in any form, including being deployed as an independent program or as a module, component, subroutine, or another unit suitable for use in a computing environment.

As an example, the computer-executable instructions may be but are not necessarily corresponding to a file in a file system, and may be stored in a part of a file that stores another program or data, for example, stored in one or more scripts in a Hypertext Markup Language (HTML) document, stored in a single file dedicated to a program under discussion, or stored in a plurality of synchronous files (for example, a file that stores one or more modules, subprograms, or code parts).

As an example, the computer-executable instruction may be deployed on one electronic device for execution, or executed on a plurality of electronic devices located at one location, or executed on a plurality of electronic devices distributed at a plurality of locations and interconnected by using a communications network.

The foregoing descriptions are merely embodiments of this application and are not intended to limit the protection scope of this application. Any modification, equivalent replacement, or improvement made within the spirit and principle of this application shall fall within the protection scope of this application.

What is claimed is:

1. A synthesis method for a virtual equipment, performed by an electronic device and comprising:
displaying an equipment selection control in a synthesis interface of a virtual equipment;
displaying a target primary virtual equipment and a target secondary virtual equipment that are instructed by the equipment selection instruction to be selected in response to an equipment selection instruction triggered based on the equipment selection control, the target secondary virtual equipment matching the target primary virtual equipment; and
displaying a synthesized target virtual equipment in response to an equipment synthesis instruction, the target virtual equipment being obtained by random synthesis based on equipment attributes of the target primary virtual equipment and the target secondary virtual equipment.

2. The method according to claim 1, wherein the equipment selection control comprises a primary equipment selection control and a secondary equipment selection control, and the displaying a target primary virtual equipment and a target secondary virtual equipment that are instructed by the equipment selection instruction to be selected in response to an equipment selection instruction triggered based on the equipment selection control comprises:
displaying a primary equipment selection interface in response to a trigger operation for the primary equipment selection control, and displaying at least one candidate primary virtual equipment in the primary equipment selection interface;
displaying, in response to an equipment selection instruction for a target primary virtual equipment of the at least one candidate primary virtual equipment, the target primary virtual equipment;
displaying a secondary equipment selection interface in response to a trigger operation for the secondary equipment selection control, and displaying at least one candidate secondary virtual equipment in the secondary equipment selection interface, the candidate secondary virtual equipment matching the target primary virtual equipment; and
displaying the target secondary virtual equipment in response to an equipment selection instruction for a target secondary virtual equipment of the at least one candidate secondary virtual equipment.

3. The method according to claim 1, wherein the displaying at least one candidate secondary virtual equipment in the secondary equipment selection interface comprises:
obtaining an influencing parameter configured for influencing a selection priority of each candidate secondary virtual equipment when there are at least two candidate secondary virtual equipment, the influencing parameter comprising at least one of the following: an adaptation degree between the candidate secondary virtual equipment and the target primary virtual equipment, an equipment attribute feature of the candidate secondary virtual equipment, and a historical selection rate corresponding to the candidate secondary virtual equipment;
invoking a neural network model to perform priority prediction based on the influencing parameter, to obtain the selection priority of each candidate secondary virtual equipment, the neural network model being obtained through training by using a secondary virtual equipment sample, an influencing parameter corresponding to the secondary virtual equipment sample, and a selection priority labeled for the secondary virtual equipment sample; and
displaying each candidate secondary virtual equipment in the secondary equipment selection interface in a display style corresponding to each selection priority.

4. The method according to claim 1, wherein the method further comprises:
displaying an equipment update entry in the primary equipment selection interface or the secondary equipment selection interface;
the equipment update entry being configured for updating the at least one candidate primary virtual equipment in the primary equipment selection interface, or being configured for updating the at least one candidate secondary virtual equipment in the secondary equipment selection interface.

5. The method according to claim 1, wherein the displaying a target primary virtual equipment and a target secondary virtual equipment that are instructed by the equipment selection instruction to be selected in response to an equipment selection instruction triggered based on the equipment selection control comprises:
displaying an equipment selection interface in response to a trigger operation for the equipment selection control, the equipment selection interface comprising a primary equipment selection area and a secondary equipment selection area, and the primary equipment selection area comprising at least one candidate primary virtual equipment;
displaying the target primary virtual equipment in response to an equipment selection instruction for a target primary virtual equipment of the at least one candidate primary virtual equipment; and
displaying a target secondary virtual equipment instructed by the equipment selection instruction to be selected based on the target primary virtual equipment in response to an equipment selection instruction triggered in the secondary equipment selection area.

6. The method according to claim 1, wherein the displaying, in response to an equipment selection instruction triggered in the secondary equipment selection area, a target secondary virtual equipment instructed by the equipment selection instruction to be selected comprises:
displaying at least one candidate secondary virtual equipment in the secondary equipment selection area, the candidate secondary virtual equipment matching the target primary virtual equipment; and
displaying the target secondary virtual equipment in response to an equipment selection instruction for a target secondary virtual equipment of the at least one candidate secondary virtual equipment.

7. The method according to claim 1, wherein before the displaying the target primary virtual equipment, the method further comprises:
displaying at least two candidate secondary virtual equipment in a first display style in the secondary equipment selection area; and
the displaying a target secondary virtual equipment instructed by the equipment selection instruction to be selected in response to an equipment selection instruction triggered in the secondary equipment selection area, comprises:
displaying a first part of candidate secondary virtual equipment in the at least two candidate secondary virtual equipment in a second display style, and displaying a second part of candidate secondary virtual equipment in the at least two candidate secondary virtual equipment in a third display style in the secondary equipment selection area;
the second display style being configured for indicating that the first part of candidate secondary virtual equipment matches the target primary virtual equipment, and the third display style being configured for indicating that the second part of candidate secondary virtual equipment not matching the target primary virtual equipment; and
displaying the target secondary virtual equipment in response to an equipment selection instruction for a target secondary virtual equipment in the first part of candidate secondary virtual equipment.

8. The method according to claim 1, wherein the method further comprises:
displaying selection prompt information in response to a selection operation for a candidate secondary virtual equipment in the second part of candidate secondary virtual equipment;
the selection prompt information being configured for prompting to reject selection of the candidate secondary virtual equipment not matching the target primary virtual equipment, or being configured for prompting to reselect a candidate secondary virtual equipment matching the target primary virtual equipment.

9. The method according to claim 1, wherein before the displaying a synthesized target virtual equipment in response to an equipment synthesis instruction, the method further comprises:
displaying a synthesis preview control; and
displaying a synthesis preview interface in response to a trigger operation for the synthesis preview control, and displaying an equipment attribute range of a preview virtual equipment synthesized based on the target primary virtual equipment and the target secondary virtual equipment in the synthesis preview interface;
the equipment attribute range comprising at least one of the following: a basic attribute range and a special effect attribute range, configured for reference to determine whether to trigger the equipment synthesis instruction.

10. The method according to claim 1, wherein the method further comprises:
displaying an equipment field guide entry for the preview virtual equipment in the synthesis preview interface; and
displaying an equipment field guide display interface in response to a trigger operation for the equipment field guide entry, and displaying an equipment field guide of the preview virtual equipment in the equipment field guide display interface.

11. The method according claim 1, wherein the displaying a synthesized target virtual equipment in response to an equipment synthesis instruction comprises:
displaying an equipment synthesis control; and
displaying a synthesis result interface in response to an equipment synthesis instruction triggered based on the equipment synthesis control, and displaying a target virtual equipment and an equipment parameter of the target virtual equipment in the synthesis result interface;
the equipment parameter of the target virtual equipment comprising a basic attribute parameter and a special effect attribute parameter, and being obtained by random synthesis of an equipment parameter of the target primary virtual equipment and an equipment parameter of the target secondary virtual equipment.

12. The method according to claim 1, wherein the displaying a target virtual equipment and an equipment parameter of the target virtual equipment in the synthesis result interface comprises:
displaying an erasable coating in an associated area of the equipment parameter in the synthesis result interface, and gradually uncovering an equipment parameter blocked by the erasable coating in the associated area in response to an erase operation for the erasable coating; or
displaying a one-click/tap uncover control in the synthesis result interface, and in response to a trigger operation for the one-click/tap uncover control, unblocking, by one click/tap, an equipment parameter blocked by the erasable coating in the associated area;
displaying a confirming synthesis control in response to that the equipment parameter blocked by the erasable coating in the associated area is completely uncovered; and
displaying a synthesized target virtual equipment and an equipment parameter of the target virtual equipment in response to a trigger operation for the confirming synthesis control.

13. The method according to claim 1, wherein the method further comprises:
displaying an abandon synthesis control in a process of displaying the confirming synthesis control; and
displaying abandonment prompt information in response to a trigger operation for the abandon synthesis control;
the synthesis abandonment prompt information being configured for prompting that after synthesizing the target virtual equipment based on the target primary virtual equipment and the target secondary virtual equipment is abandoned, an equipment attribute of the target primary virtual equipment is reserved, and an equipment attribute of the target secondary virtual equipment is decomposed to obtain a virtual resource.

14. The method according to claim 1, wherein the displaying a synthesized target virtual equipment in response to an equipment synthesis instruction comprises:
displaying a target virtual equipment synthesized by using the target primary virtual equipment and the target secondary virtual equipment in response to an equipment synthesis instruction when equipment quality of the target primary virtual equipment is higher than equipment quality of the target secondary virtual equipment;
the target virtual equipment reserving the equipment quality of the target primary virtual equipment.

15. The method according to claim 1, wherein the method further comprises:
displaying synthesis prompt information when the equipment quality of the target primary virtual equipment is lower than the equipment quality of the target secondary virtual equipment;
the synthesis prompt information being configured for prompting to inherit the equipment attribute of the target secondary virtual equipment to at least two other secondary virtual equipment, and perform equipment synthesis based on the inherited target secondary virtual equipment and the target primary virtual equipment, or perform equipment synthesis based on the inherited other secondary virtual equipment and the target primary virtual equipment; and
equipment quality of the inherited target secondary virtual equipment or equipment quality of the inherited other secondary virtual equipment being lower than the equipment quality of the target primary virtual equipment, and the inherited other secondary virtual equipment matching the target primary virtual equipment.

16. The method according to claim 1, wherein the displaying a synthesized target virtual equipment in response to an equipment synthesis instruction comprises:
presenting an equipment synthesis special effect in response to an equipment synthesis instruction; and
stopping presenting the equipment synthesis special effect in response to that a special effect presentation stop condition is satisfied, and displaying the synthesized target virtual equipment, the special effect presentation stop condition comprising at least one of the following: presentation duration of the equipment synthesis special effect reaches target duration, a quantity of presentation times of the equipment synthesis special effect reaches a target quantity of times, and an operation for closing the equipment synthesis special effect is received.

17. An electronic device, comprising:
a memory, configured to store computer-executable instructions; and
a processor, configured to execute the computer-executable instructions stored in the memory to implement:
displaying an equipment selection control in a synthesis interface of a virtual equipment;
displaying a target primary virtual equipment and a target secondary virtual equipment that are instructed by the equipment selection instruction to be selected in response to an equipment selection instruction triggered based on the equipment selection control, the target secondary virtual equipment matching the target primary virtual equipment; and
displaying a synthesized target virtual equipment in response to an equipment synthesis instruction, the target virtual equipment being obtained by random synthesis based on equipment attributes of the target primary virtual equipment and the target secondary virtual equipment.

18. The device according to claim 17, wherein the equipment selection control comprises a primary equipment selection control and a secondary equipment selection control, and the displaying a target primary virtual equipment and a target secondary virtual equipment that are instructed by the equipment selection instruction to be selected in response to an equipment selection instruction triggered based on the equipment selection control comprises:
displaying a primary equipment selection interface in response to a trigger operation for the primary equipment selection control, and displaying at least one candidate primary virtual equipment in the primary equipment selection interface;
displaying, in response to an equipment selection instruction for a target primary virtual equipment of the at least one candidate primary virtual equipment, the target primary virtual equipment;
displaying a secondary equipment selection interface in response to a trigger operation for the secondary equipment selection control, and displaying at least one candidate secondary virtual equipment in the secondary equipment selection interface, the candidate secondary virtual equipment matching the target primary virtual equipment; and
displaying the target secondary virtual equipment in response to an equipment selection instruction for a target secondary virtual equipment of the at least one candidate secondary virtual equipment.

19. The device according to claim 17, wherein the displaying at least one candidate secondary virtual equipment in the secondary equipment selection interface comprises:
obtaining an influencing parameter configured for influencing a selection priority of each candidate secondary virtual equipment when there are at least two candidate secondary virtual equipment, the influencing parameter comprising at least one of the following: an adaptation degree between the candidate secondary virtual equipment and the target primary virtual equipment, an equipment attribute feature of the candidate secondary virtual equipment, and a historical selection rate corresponding to the candidate secondary virtual equipment;
invoking a neural network model to perform priority prediction based on the influencing parameter, to obtain the selection priority of each candidate secondary virtual equipment, the neural network model being obtained through training by using a secondary virtual equipment sample, an influencing parameter corresponding to the secondary virtual equipment sample, and a selection priority labeled for the secondary virtual equipment sample; and
displaying each candidate secondary virtual equipment in the secondary equipment selection interface in a display style corresponding to each selection priority.

20. A non-transitory computer-readable storage medium, having computer-executable instructions stored thereon, when executed by a processor, the computer-executable instructions causing the processor to implement:
displaying an equipment selection control in a synthesis interface of a virtual equipment;
displaying a target primary virtual equipment and a target secondary virtual equipment that are instructed by the equipment selection instruction to be selected in response to an equipment selection instruction triggered based on the equipment selection control, the target secondary virtual equipment matching the target primary virtual equipment; and
displaying a synthesized target virtual equipment in response to an equipment synthesis instruction, the target virtual equipment being obtained by random synthesis based on equipment attributes of the target primary virtual equipment and the target secondary virtual equipment.
